(19) United States
(12) Patent Application Publication
(10) Pub. No.: US 2025/0193343 A1
(43) Pub. Date: Jun. 12, 2025

(54) DYNAMICALLY MANAGING REMOTE CONFERENCING WHILE DRIVING

(71) Applicant: Adeia Guides Inc., San Jose, CA (US)

(72) Inventors: Zhiyun Li, Kenmore, WA (US); Reda Harb, Tampa, FL (US); Serhad Doken, Bryn Mawr, PA (US); Ning Xu, Irvine, CA (US)

(21) Appl. No.: 18/532,034

(22) Filed: Dec. 7, 2023

(51) Int. Cl. H04N 7/15; B60W 30/182; B60W 50/14; B60W 60/00; G06V 20/59; G06V 40/16

(52) U.S. Cl. CPC H04N 7/157; B60W 30/182; B60W 50/14; B60W 60/001; G06V 20/597; G06V 40/174; B60W 2050/146; B60W 2420/403; B60W 2540/225

(57) ABSTRACT

Systems and methods for configuring video conferencing adaptations for a user interface (UI) of a driver's conferencing device based on a driving mode of an autonomous vehicle are described. A mode of operation of the autonomous vehicle when a video conferencing call is or will be in progress is determined. A route taken by the autonomous vehicle may include some segments that allow an autonomous mode of driving while other segments may not. Different adaptations may be configured for the driver and/or non-driver's UI for their conference devices based on the determined mode of operation such that advanced call feature capability may be provided while ensuring driver safety while driving. These adaptations include displaying still images instead of live video of participants, presenting video conferencing scheduling or alert options based on mode of operation, and an option to bookmark a point in the video conference.

### FIELD OF INVENTION

Embodiments of the present disclosure relate to managing conferencing for a driver of an autonomous vehicle by adapting the conferencing user interface of an audio/video conferencing application for the driver and the caller based on the mode of operation of an autonomous vehicle, such as autonomous versus non-autonomous driving.

### BACKGROUND

Remote conferencing, especially video conferencing, has been for some time the most efficient way to connect people. Video conferencing became the most preferred method of conducting a multi-participant meeting during the Covid-19 pandemic. People have become used to it and continue to use it on a daily basis ever since. In the enterprise context, workers who work from home or are in different locations of a company frequently schedule and meet on a video conference, such as Zoom™ or Google Meet™.

While engaged in a video conference, participants multitask and perform other functions. Processing these multiple tasks in parallel, such as reading presentation slides being shared by one or more participants, taking notes, gauging other people's reactions, making decisions, etc., demands a high level of cognitive load.

Typically, video conferencing is conducted using laptops, tablets, and smart phones. Participants log on to their accounts and conduct video conference meetings in which each participant can see the others and use various video conferencing tools such as sharing documents, presenting a slide deck, blurring their background, etc. Newer trends offer video conferencing in autonomous vehicles, such as Tesla™.

Some reports have indicated that autonomous vehicles, such as Tesla™, may include a Zoom Tesla application that would allow users to dial into a meeting while the car is parked. The car's interior camera and microphone are used. To provide more flexibility beyond just being able to do a video conference while parked, some advancement includes allowing participants to schedule a video conference while driving. For example, U.S. Patent U.S. Pat. No. 10,362,068B2 describes a scheduling unit that will plan the video conference for a period when most of the participating vehicles are in autonomous driving mode. For a vehicle in non-autonomous driving mode, the conference will be in non-video mode. However, the system is limited to providing video conferencing capabilities only while the participating vehicles are in autonomous driving mode.

In another example, U.S. Patent U.S. Pat. No. 10,666,901B1 describes a system to monitor and evaluate the stress level of an occupant, e.g., a baby, of the vehicle by sensors and cameras. If the occupant is determined to be too stressed, the system will initiate a video call with his contacts. However, this system is not designed for the driver; instead, it is mainly to soothe the passengers, such as small children, by automatically initiating video calls.

Although some advancements have been made to offer video conferencing in an autonomous vehicle, these advancements are limiting and do not provide flexibility to the driver to conduct the video conference if the driver is not in autonomous mode or parked. As such, there is a need for robust video conferencing methods and systems that provide additional video conferencing flexibility while in an autonomous vehicle and overcome some of the above-mentioned limitations.

### BRIEF DESCRIPTION OF THE DRAWINGS

The various objects and advantages of the disclosure will be apparent upon consideration of the following detailed description, taken in conjunction with the accompanying drawings, in which like reference characters refer to like parts throughout, and in which:

FIG. 1 is a block diagram of a process of determining a mode of operation of an autonomous vehicle, adapting a user interface based on the mode of operation, and providing conferencing tools, in accordance with some embodiments of the disclosure;

FIG. 2 is a block diagram of an example system for determining a mode of operation of an autonomous vehicle, adapting a user interface based on the mode of operation, and providing conferencing tools, in accordance with some embodiments of the disclosure;

FIG. 3 is a block diagram of a conferencing device used for joining a video conference and displaying conferencing tools, in accordance with some embodiments of the disclosure;

FIG. 4 is an example of a conferencing device integrated into an autonomous vehicle, in accordance with some embodiments of the disclosure;

FIG. 5 is a flowchart of a process of planning a conference call in which a driver of an autonomous vehicle would be a participant and adapting the conferencing user interface based on the mode of operation of the autonomous vehicle, in accordance with some embodiments of the disclosure;

FIG. 6 is a flowchart of a process of tracking changes in mode of operation of an autonomous vehicle and adapting the conferencing user interface based on the tracked changes, in accordance with some embodiments of the disclosure;

FIG. 7 is a flowchart of a process adapting the user interface of a conferencing device associated with an autonomous vehicle based on the type of files that are to be presented during a video conference call, in accordance with some embodiments of the disclosure;

FIG. 8 is a flowchart of a process depicting changes from still images to live video and vice versa based on the current mode of operation of the autonomous vehicle, in accordance with some embodiments of the disclosure;

FIG. 9 is a block diagram of various adaptations that may be configured for the user interface associated with the conferencing device used by the driver of an autonomous vehicle, in accordance with some embodiments of the disclosure;

FIG. 10 is a block diagram of various adaptations that may be configured for the user interface associated with the conferencing device used by the participant (non-driver) of the video conference call, in accordance with some embodiments of the disclosure;

FIG. 11 is a block diagram of categories of data that may be published by the autonomous vehicle, in accordance with some embodiments of the disclosure;

FIG. 12 is an example of a route that may be taken by the autonomous vehicle and various autonomous and non-autonomous segments along that route, in accordance with some embodiments of the disclosure;

FIG. 13 is an example of an adaptation on the user interface (UI) of a non-driver participant that allows configuration of audio or video settings for the video conference call, in accordance with some embodiments of the disclosure;

FIG. 14 is an example of implementing the audio/video settings of a video conference call based on the vehicle's mode of operation, in accordance with some embodiments of the disclosure;

FIG. 15 is a block diagram of categories of bookmarking options for bookmarking segments of a video conference call, in accordance with some embodiments of the disclosure;

FIG. 16 is an example of a snapshot of a road used as a bookmark, in accordance with some embodiments of the disclosure;

FIG. 17 is an example of a different types of bookmarks stored as part of the recording of the video conference call, in accordance with some embodiments of the disclosure;

FIG. 18 is a flowchart of communications between a plurality of devices for determining a mode of operation of an autonomous vehicle, adapting a user interface based on the mode of operation, and providing conferencing tools, in accordance with some embodiments of the disclosure; and

FIG. 19 is an example of an autonomous vehicle that include multiple displays that may be used as conferencing devices, in accordance with some embodiments of the disclosure.

### DETAILED DESCRIPTION

In accordance with some embodiments disclosed herein, some of the above-mentioned limitations are overcome by configuring different adaptations for a user interface (UI) of one or more conferencing devices based on a mode of operation of an autonomous vehicle. Systems and methods are used to determine the mode of operation of an autonomous vehicle. The mode of operation may be determined when an invite is received to join the driver of the autonomous vehicle to an ongoing video conference call or in the planning stages of the video conferencing call. The modes of operation may include an autonomous mode, a non-autonomous mode, or another mode, such as a parking or parked mode.

In some embodiments, a video conferencing call may be established between a plurality of devices. The video conference call may be a Zoom™ or Google Meet™ call or it may be a Facetime™, WhatsApp™ call. It may also be a video call from any other type of video calling platform. At least one of the devices, from the plurality of devices may be associated with the autonomous vehicle, such as a device that is integrated into the hardware of the autonomous vehicle and running a native conferencing application to the autonomous vehicle that allows engaging in the video conference call. When the video conferencing call is in progress, a participant of the video conferencing call may invite another individual who is a driver of an autonomous vehicle to the video conferencing call. The request may trigger a determination of the mode of operation of the autonomous vehicle. The mode of operation may be used, among other things, as a safety guide to configure a UI adaptation for the video conferencing device used by the driver while in an autonomous vehicle. The UI adaptation may provide different video conferencing features based on the mode of operation of the autonomous vehicle, thereby allowing the driver of an autonomous vehicle to engage in the video conferencing call in several ways.

If a determination is made that the current mode of operation of the autonomous vehicle when the driver is being added to the video conference is in a non-autonomous mode, i.e., the autonomous vehicle is being driven manually or in a non-autonomous manner, the UI of the driver's conferencing device may be configured to provide non-autonomous adaptations. These non-autonomous adaptations may include a voice-only conference call, replacement of live video of meeting participants with a still image, and bookmarking options for the driver to bookmark a segment of the video conference call. The UI of a participant who is a non-driver may also be configured based on a determination that the driver of the autonomous vehicle, who is being added, is currently driving in a non-autonomous mode. These non-autonomous adaptations for the non-driver participant of the video conference call may include selecting a voice-only conference call, rescheduling the video conference call for when the driver is driving in an autonomous mode, and receiving alerts that inform the caller (i.e., the non-driver participant) when the change of mode of operation occurs from the non-autonomous mode to an autonomous mode. The UI of a participant who is a non-driver may also be configured to allow selection of an importance level of the meeting. The importance level selection may be used by the system to suggest alternative routes to the driver, which may allow the driver to drive in an autonomous mode while the video conferencing call, or at least a critical segment of the video conferencing call, is being conducted.

If a determination is made that the current mode of operation of the autonomous vehicle when the driver is being added to the video conference is in an autonomous mode, i.e., the autonomous vehicle is being driven automatically, the UI of the driver's conferencing device may be configured to provide autonomous adaptations. These autonomous adaptations for the driver's conferencing device may include displaying a live video of the participants and displaying duration of the autonomous mode. The autonomous adaptations for the non-driver's conferencing device may include displaying a live video of the driver, displaying duration of the autonomous mode, and allowing the participant to reshuffle meeting agenda such that a critical segment of the meeting can be conducted while the driver's autonomous vehicle is still in the autonomous mode.

In other embodiments, a video conferencing call may not yet be in progress and may be in its scheduling stage. In this embodiment, a participant may be trying to schedule the video conference call at a future time, or at a current time, with a driver who may be driving the autonomous vehicle in a non-autonomous mode at the time of the scheduled video conference call. The system may determine a future status of the driver's autonomous vehicle based on the scheduled time of the video conference call. To do so, the system may access one or more data sources associated with the driver, such as the driver's calendar, route map, emails, texts, etc. Data obtained from the sources may be used to determine, from a route that a driver may take, whether the driver is likely to be in the autonomous vehicle at the time of the scheduled call. Since some segments of the route may include segments where the autonomous vehicle may be driven in an autonomous mode and other segments where it may be driven in a non-autonomous mode, the system may determine which segment may be driven at the time of the scheduled video conference call. If a determination is made that at the time of the scheduled conference call the autonomous vehicle will be driven in an autonomous mode, then autonomous adaptations may be implemented on the driver's and/or the non-driver's conferencing devices. If a determination is made that at the time of the scheduled conference call the autonomous vehicle will be driven in a non-autonomous mode, then non-autonomous adaptations may be implemented on the driver's and/or the non-driver's conferencing devices.

The systems may continue to monitor the changes in modes of operation of the autonomous vehicle, such as from autonomous mode to non-autonomous mode or vice versa. The adaptations may be updated in real time based on the determined changes in mode of operation.

The systems may also determine all segments of a route currently taken, or to be taken, by a driver and determine which segments of the route allow the autonomous vehicle to operate in an autonomous manner and which do not. The data may be shared with a server associated with conferencing application, such that it can be used to plan video conferencing calls involving the driver. The data may be available to anyone that wishes to access the data, or it may be private and require login or some other approval from the entity that wishes to access the data. The data may be shared directly with the caller device or may be shared on a platform, such as an application platform, cloud platform, video conferencing platform, etc., that may be accessible by all devices, by the caller device, or by authorized devices. For example, a video conferencing call may be scheduled to coincide with the segment of the route that is being driven autonomously such that the driver may be able to gaze at the UI of the driver's conferencing device during the video conference call.

The systems may also provide various bookmarking options for the driver of the autonomous vehicle to use wake words, commands, and gestures to bookmark a point in the video conference call such that the driver may be able to refer to it at a later time. These bookmarking options may include voice notes, snapshots of the road visible from the autonomous vehicle, screenshots of the documents presented in the video conference call, incorporating, or associating notes with the documents presented during the video conference call, or screenshots of the navigation system.

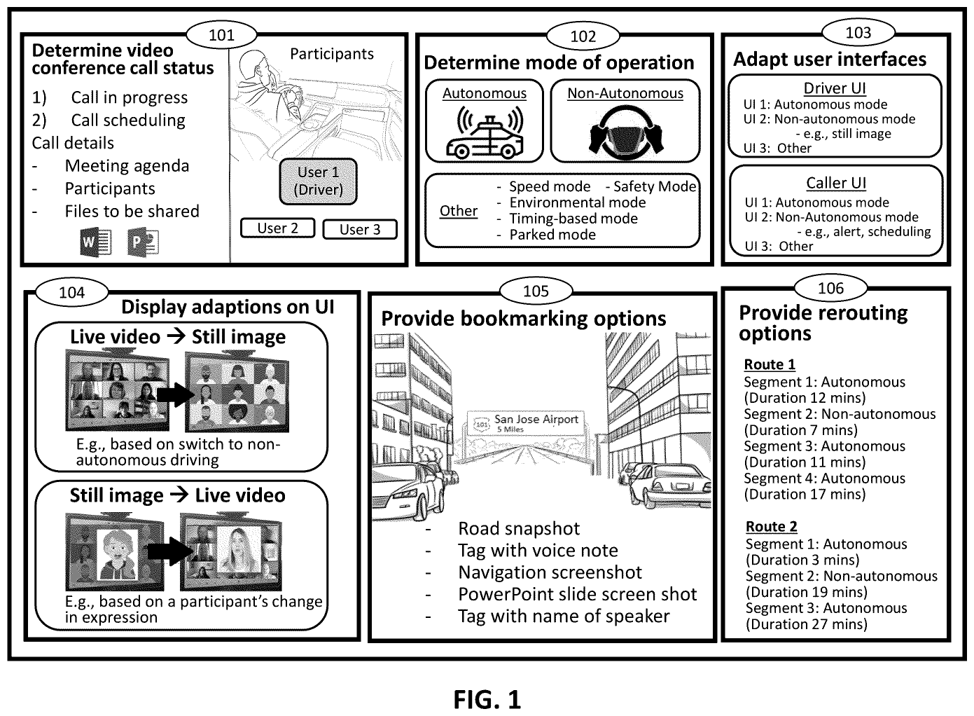

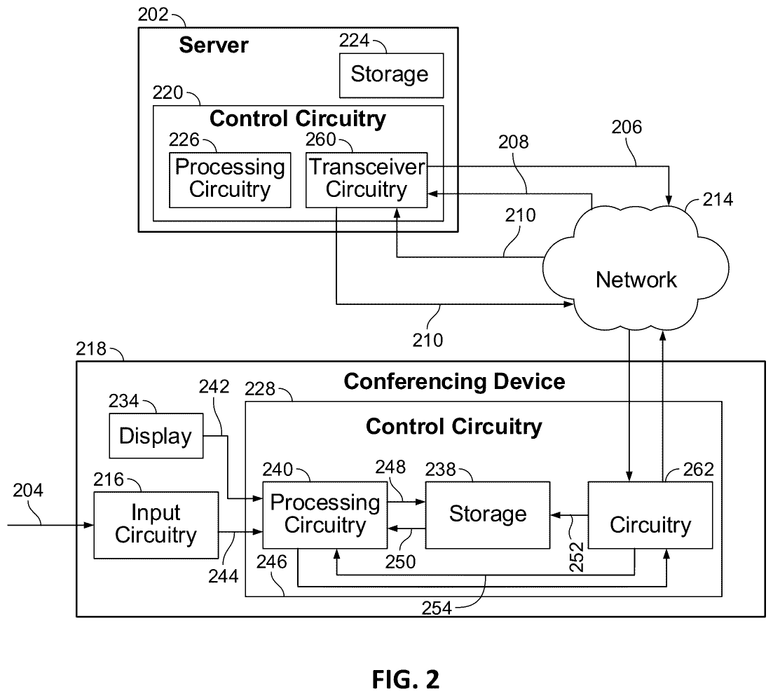

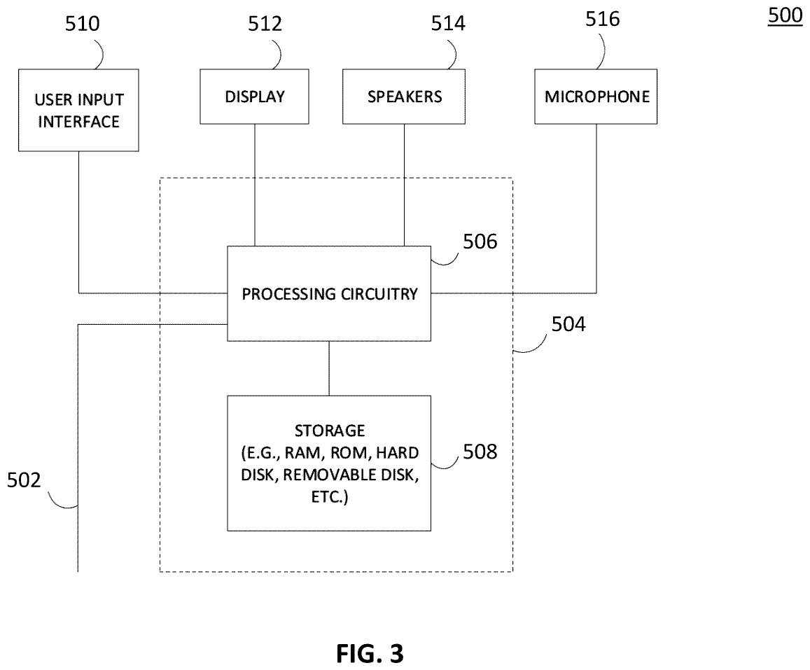

Turning to the figures, FIG. 1 is a block diagram of a process 100 of determining a mode of operation of an autonomous vehicle, adapting a user interface based on the mode of operation, and providing conferencing tools, in accordance with some embodiments of the disclosure. The process 100 may be implemented, in whole or in part, by systems or devices such as those shown in FIGS. 2 and 3. One or more actions of the process 100 may be incorporated into or combined with one or more actions of any other process or embodiments described herein. The process 100 may be saved to a memory or storage (e.g., any one of those depicted in FIGS. 2 and 3) as one or more instructions or routines that may be executed by a corresponding device or system to implement the process 100.

In some embodiments, at block 101, control circuitry, such as control circuitry 220 and/or 228 of FIG. 2, may determine a video conference call status. There may be at least two embodiments of conference call status, a first embodiment in which a video conference call is already in progress and a second embodiment in which the video conference call is not yet in progress and is in its planning stage, to be scheduled.

The video conference call may be between a driver of an autonomous vehicle and one or more participants that are not currently in an autonomous vehicle. Although a single driver and autonomous vehicle are used for describing the process, the embodiments are not so limited, and a conference call may include a plurality of participants of which a subset of the participants may be in an autonomous vehicle and another subset of the participants may not be in an autonomous vehicle.

As used herein, the term “autonomous vehicle” may include a self-driving vehicle that includes a plurality of sensors and cameras for sensing and viewing its environment and operating without human involvement, in other words, a vehicle that is capable of automatically, autonomously navigating the road based on input from its sensors and cameras and of which a human passenger may take control. Some examples of such autonomous vehicles include Tesla Model S™, Mercedes-Benz EQS™, BMW iX3™ and autonomous trucks such that are made by Kodiak Robotics™ or Tevva Motors™. Other examples of autonomous vehicles may include other types of wheeled vehicles that are capable in operating in an autonomous mode.

As used herein, “autonomous mode” or “driving in an autonomous mode” may refer to driving of the autonomous vehicle in its self-driving state with little or no human intervention by the driver at least for some duration along a path. “Autonomous mode” may also refer to a state of driving in which the car is being driven at a speed below a threshold (also referred to as speed mode); in a rural area with little to no traffic (also referred to as environmental mode); when the car is being driven by leveraging advanced driver assistance systems (ADAS), during off-peak hours (also referred to as timing-based mode), such as 11:00 p.m., or 7:00 a.m. on a Sunday or holiday; or in a location or at a time when the risk of an accident or collision is very low or below a threshold (also referred to as safety mode). In other words, “autonomous mode” may also refer to any state of driving in which minimal interaction by the driver is required and it is safe for the driver to simultaneously drive and focus on other events, such as a video conference call, including parked mode, speed mode, environmental mode, timing-based mode, and safety mode.

In a first embodiment, at block 101, a video conference call may be in progress. A participant of the video conference call may invite the driver of an autonomous vehicle to the ongoing video conference call. The equipment used by the driver of the autonomous vehicle to receive the call may vary. For example, the equipment may be a smart phone, a navigation system, a video conferencing device integrated into the vehicle such as in the dashboard area, a laptop or tablet that the user may mount at some location in the autonomous vehicle, or any other type of display device that is either a standalone device or a device that can be partially or fully integrated into the autonomous vehicle. As referred to herein, “driver conferencing device,” “driver's conferencing device,” or “autonomous vehicle conferencing device” includes any of the equipment described above.

The driver conferencing device may include a conferencing user interface (UI). This conferencing UI in the driver conferencing device may allow the driver to perform all typical conferencing call actions. For example, this conferencing UI in the driver conferencing device may allow the driver of the autonomous vehicle to receive or make a video conference call, receive or make an audio conference call, display participants in a video conference call, display/share files and documents in a video conference call, record an ongoing conference call, save files displayed in a video conference call (e.g. meeting slides, Word documents, etc.), save a conference call recording, schedule a conference call, and play back a recorded conference call. In one embodiment, the driver conferencing device may be integrated into the hardware of the autonomous vehicle. The integrated driver conferencing device may use an application that is native to the autonomous vehicle to communicate and engage with the video conference call, e.g., the video conferencing application may be native to the autonomous vehicle. The driver conferencing device may be integrated or tied into the audio/video conferencing application and/or the UI of the user device (e.g., infotainment system of the autonomous vehicle.)

When a video conference call is in progress, in one embodiment, the conferencing UI of the driver conferencing device or conferencing application may receive a request to add the driver to the video conference call. The driver conferencing device, or a server associated with the driver conferencing device, may analyze a plurality of factors to determine whether to join the driver to the ongoing video conference call. One of the factors analyzed, among the plurality of factors, is the safety of the driver when the driver is driving the autonomous vehicle in a non-autonomous mode, i.e., driving it manually. For example, if the driver is manually driving the car in a high-density traffic area that requires a higher level of the driver's attention on the road, then a determination may be made that it is not safe for the driver to gaze at the conferencing UI in the driver conferencing device while driving the car. Accordingly, the conferencing UI in the driver conferencing device may be adapted to provide a safer conferencing option to the driver rather than the driver having to gaze at the ongoing video call.

In another embodiment, the video call may not be in progress. For example, another user may initiate a call, such as a video conferencing call or a Facetime™, WhatsApp™, or another type of call and invite the driver to be added.

In another embodiment, at block 101, a video conference call may be scheduled and not yet in progress. In such an embodiment, a calendar or conference scheduling tool may be used to send a meeting request to the driver of the autonomous vehicle. The meeting request (i.e., a video conference call request), similar to a typical conference call meeting request, may include the time and date of the scheduled video conference call, participants that are invited to join the call; agenda of the call; and files, such as slides or documents, that are to be shared during the call.

When a request to add the driver to an ongoing video conference call is received, the control circuitry 220 and/or 228, at block 102, may determine the mode of operation of the autonomous vehicle. Determining the mode of operation may allow the control circuitry 220 and/or 228 to adapt the conferencing UI in the driver conferencing device to a current mode of operation. Adapting the UI based on the mode of operation of the autonomous vehicle would make it safer for the driver to engage in the video conference call while continuing in the current mode of operation.

In some embodiments, the mode of operation of the autonomous vehicle, as depicted at block 102, may include autonomous mode, non-autonomous mode, parked mode, and other modes, such as speed mode (where the vehicle is being operated below a threshold speed), environmental mode (such as driving in a rural area or in a certain environment), a timing-based mode (such as driving at a certain time of the day or week when traffic is less dense), or safety mode (such as driving in a manner in which the safety risk is low).

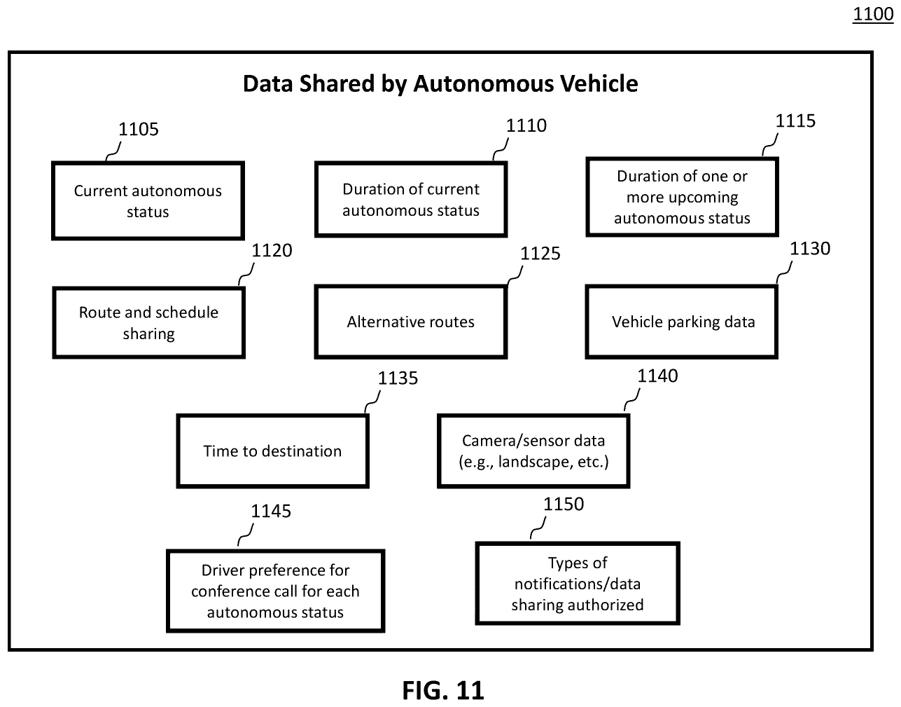

In some embodiments, the autonomous vehicle, the driver conferencing device, or a server associated with the autonomous vehicle or driver conferencing application may publish the current mode of operation of the autonomous vehicle to a server that can be accessed by other authorized application(s). An application (e.g., a native application that is accessible from the vehicle's infotainment system) may access a vehicles' current state (e.g., parked, driving on a segment of a route that supports autonomous driving, currently operating in autonomous mode, etc.) by accessing information from the electronic control unit (ECU of the vehicle. The applications may be authorized to have a read-only access to data associated with specific systems related to speed, mode, etc. Similarly, applications that are running on devices such as smart phones may also access data associated with the vehicle that they're located in and make such data available to other apps such as video/audio calling apps, apps with text or voice-based messaging capabilities, etc. This is possible if a device such as a phone is capable of connecting to the vehicles infotainment system via known technologies, such direct connect through USB, or wirelessly through Bluetooth, Wi-Fi, Wi-Fi Direct, etc. For example, if the current mode of operation is autonomous mode, then such current status may be published or broadcasted. In some embodiments, the information may be published publicly such that it can be accessed by any other server or conferencing device. In other embodiments, the information may be published privately to selected servers or conferencing devices. In yet another embodiment, the information may be transmitted to other servers or conferencing devices once they have been authorized. Some examples of published information are described in relation to FIG. 11.

The published information may be used to configure or adapt the conferencing user interface to correspond to the current mode of operation of the autonomous vehicle. In some embodiments, the conferencing user interface that is adapted to correspond to the current mode of driving is the conferencing UI in the driver conferencing device. In other embodiments, the conferencing user interface that is adapted to correspond to the current mode of driving is the conferencing UI in the participant's conferencing device, i.e., a participant that is not a driver. In yet another embodiment, the conferencing user interface that is adapted to correspond to the current mode of driving is both the conferencing UI in the driver conferencing device and the conferencing UI in all conferencing devices of other participants (that are not drivers) and engaged in the video conference call.

In some embodiments, the mode of operation of the autonomous vehicle determined at block 102 may be that the autonomous vehicle is currently being driven in an autonomous mode. In some embodiments, the control circuitry 220 and/or 228 may make the determination by accessing a computer system associated with the autonomous vehicle to determine whether the autonomous vehicle is being driven in autonomous mode. In other embodiments, the control circuitry 220 and/or 228 may make the determination based on information published by the autonomous vehicle or a server associated with the autonomous vehicle.

As described earlier, autonomous mode is a mode in which the vehicle is driven automatically or in self-driving state. In this embodiment, the autonomous vehicle's computing system receives input of the autonomous vehicle's surroundings from sensors and cameras associated with autonomous vehicle. This input may include location of other vehicles in proximity to the autonomous vehicle, a map of the road ahead, lane markers for each lane, signal lights ahead, and several other details of the road and traffic density that can be used by the autonomous vehicle to automatically drive the car with little or no input from the driver. When the autonomous vehicle is in the autonomous mode, it allows the driver of the autonomous vehicle to focus on other events, such as the video conference call, while still being able to drive.

In some embodiments, the mode of operation of the autonomous vehicle determined at block 102 may be that the autonomous vehicle is currently being driven in a non-autonomous mode. In some embodiments, the control circuitry 220 and/or 228 may access a computer system associated with the autonomous vehicle to determine whether the autonomous vehicle is being driven in autonomous mode. In other embodiments, the control circuitry 220 and/or 228 may make the determination based on information published by the autonomous vehicle or a server associated with the autonomous vehicle.

As described earlier, non-autonomous mode or manual driving is a mode in which the vehicle is driven manually by the driver and not controlled automatically by any computing systems or artificial intelligence (AI) associated with the autonomous vehicle. When the autonomous vehicle is in the non-autonomous mode, it requires the driver of the autonomous vehicle to focus on road as the vehicle is not being automatically driven. As such, the driver may not be able to focus their attention to other events besides driving, such as engaging with a video conference call and gazing at the video conference display. Even if the driver is able to gaze at the video conference call, the control circuitry 220 and/or 228 may determine that doing so increases the safety risk above a predetermined safety threshold.

In some embodiments, the mode of operation of the autonomous vehicle determined at block 102 is that the autonomous vehicle is currently being driven below a threshold speed. The threshold speed may be predetermined or may be determined based on conditions surrounding the autonomous vehicle. For example, the predetermined speed may be 20 MPH. In another embodiment, the predetermined speed may be 50% (or some other percentage) of the rated speed for the road on which the autonomous vehicle is currently traveling. For example, if the autonomous vehicle is being driven on a highway where the rated speed is 70 mph, then the threshold may be set at 35 mph or 50 mph, or some other number below the rated speed. If the autonomous vehicle is being driven on residential streets where the rated speed is 25 mph, then, in another non-limiting example, the threshold may be set at 10 mph.

In other embodiments, the autonomous vehicle's threshold speed may be determined dynamically based on its surroundings and safety factors associated with its surroundings. For example, if driving on the road requires a higher level of focus, such as when the road is curvy, has a high level of up and down terrain, includes obstacles such as roundabouts, or if the weather conditions, such as rain, snow, or fog, make the driving challenging, then a lower level of speed may be determined to be set as the autonomous vehicle's threshold speed. In another embodiment, if such challenging settings surround the autonomous vehicle as the vehicle is being driven, then the control circuitry 220 and/or 228 may not set any threshold speed at all and may determine that the driver needs to continuously focus on the road.

In some embodiments, whatever the threshold speed it set at, the control circuitry 220 and/or 228 may access a computer system associated with the autonomous vehicle to determine whether the autonomous vehicle is being driven below the threshold speed. In other embodiments, the control circuitry 220 and/or 228 may make the determination based on information published by the autonomous vehicle or a server associated with the autonomous vehicle.

In some embodiments, a determination is made by the control circuitry 220 and/or 228 that the autonomous vehicle is being driven below the threshold speed. The control circuitry 220 and/or 228 may then associate such a determination with the autonomous vehicle requiring a lesser amount of attention from the driver since the surrounding conditions make is safe for the driver to simultaneously drive and perform other tasks, such as engaging in the video conference call.

In other embodiments, a determination is made by the control circuitry 220 and/or 228 that the autonomous vehicle is being driven above the threshold speed. The control circuitry 220 and/or 228 may then associate such a determination with the autonomous vehicle requiring a higher amount of attention from the driver since the surrounding conditions make it unsafe for the driver to simultaneously drive and perform other tasks, such as engaging in the video conference call.

In some embodiments, the mode of operation of the autonomous vehicle determined at block 102 may be that the autonomous vehicle is currently being driven in a rural area (also referred to as environmental mode). In some embodiments, the control circuitry 220 and/or 228 may make the determination by accessing a computer system associated with the autonomous vehicle to determine whether the autonomous vehicle is being driven in a rural area. In other embodiments, the control circuitry 220 and/or 228 may access the car's navigation system, GPS satellite data, or some other map, to determine the current path of the autonomous vehicle and determine whether that path is in a rural area. In yet embodiments, the control circuitry 220 and/or 228 may make the determination based on information published by the autonomous vehicle or a server associated with the autonomous vehicle.

Rural areas, as used herein, may refer to area with a lesser traffic density. These areas may include one lane roads, farmlands, desert lands, areas far from a city, etc. Driving in such rural areas may not require a higher level of focus from the driver of the autonomous vehicle since there are not many changes in the road or higher density traffic that would be a safety concern. As such, the driver may be able to focus their attention on other events besides driving, such as engaging in a video conference call and gazing at the video conference display.

In some embodiments, the mode of operation of the autonomous vehicle determined at block 102 may be that the autonomous vehicle is currently being operated at a certain time of day, time of week, or on a holiday that can be associated with lesser traffic density. For example, the autonomous vehicle may be driven at 11:00 p.m., 7:00 a.m. on a Sunday morning, or on Christmas Day, when traffic is typically low on the roads. In another example, the autonomous vehicle may be driven in a city where there is a big game or in any city when a national event, such as the Superbowl, is taking place, when the traffic is typically low on the roads. The control circuitry 220 and/or 228 may make the determination by accessing a computer system associated with the autonomous vehicle to determine whether the autonomous vehicle is being driven during such time of lesser traffic. The control circuitry 220 and/or 228 may also access local calendars or calendars associated with events, news, national holiday data, and other data that would provide the information that can be used to determine whether there would be lesser traffic density on the roads. In yet other embodiments, the control circuitry 220 and/or 228 may make the determination based on information published by the autonomous vehicle or a server associated with the autonomous vehicle, such as based on its cameras and sensors that can determine traffic density neighboring the autonomous vehicle.

If a determination is made by the control circuitry 220 and/or 228 that the autonomous vehicle is being driven during a time that the traffic density is less than usual, then it may associate such a determination with the autonomous vehicle requiring a lesser amount of attention from the driver since the surrounding conditions make it safe for the driver to simultaneously drive and perform other tasks, such as engaging in the video conference call.

In some embodiments, the mode of operation of the autonomous vehicle determined at block 102 may be that the autonomous vehicle is currently being driven in a certain manner or in an area that does not put the autonomous vehicle above a risk profile or safety risk threshold. In some embodiments, the control circuitry 220 and/or 228 may access a computer system associated with the autonomous vehicle to determine whether the autonomous vehicle is being driven in autonomous mode. In other embodiments, the control circuitry 220 and/or 228 may make the determination based on information published by the autonomous vehicle or a server associated with the autonomous vehicle.

Although a few non-limiting embodiments of mode of operations have been described, the embodiments are not so limited, and other mode of operations are also contemplated. For example, in some embodiments, whether the autonomous vehicle is being driven in cruise control may be evaluated to determine whether it would require a lower or higher level of attention and focus from the driver. For example, if the cruise control is activated in the autonomous (or any other) vehicle on a long, straight highway, such as portions of the 101 highway from San Jose to Los Angeles, then the car being in cruise control may be associated with the car being driven within a safety risk profile and requiring a lesser amount of attention from the driver.

In another embodiment, although cruise control may be activated, the road conditions may be such that the driver may be required to turn cruise control on and off frequently after short durations, or the driver may be switching cruise control between on and off within a predetermined time threshold, such as every three minutes. When frequent switching of cruise control from on to off, or vice versa, occurs, then the driving status may be associated with non-autonomous driving, i.e., the car is being driven manually because conditions present a higher level of risk that is outside of the safety risk profile. As such, since the current conditions exceed the safety profile, it may require a higher or constant amount of attention from the driver while driving. Accordingly, a determination may be made that the driver may not focus on a video conference call, at least not by consuming a live video.

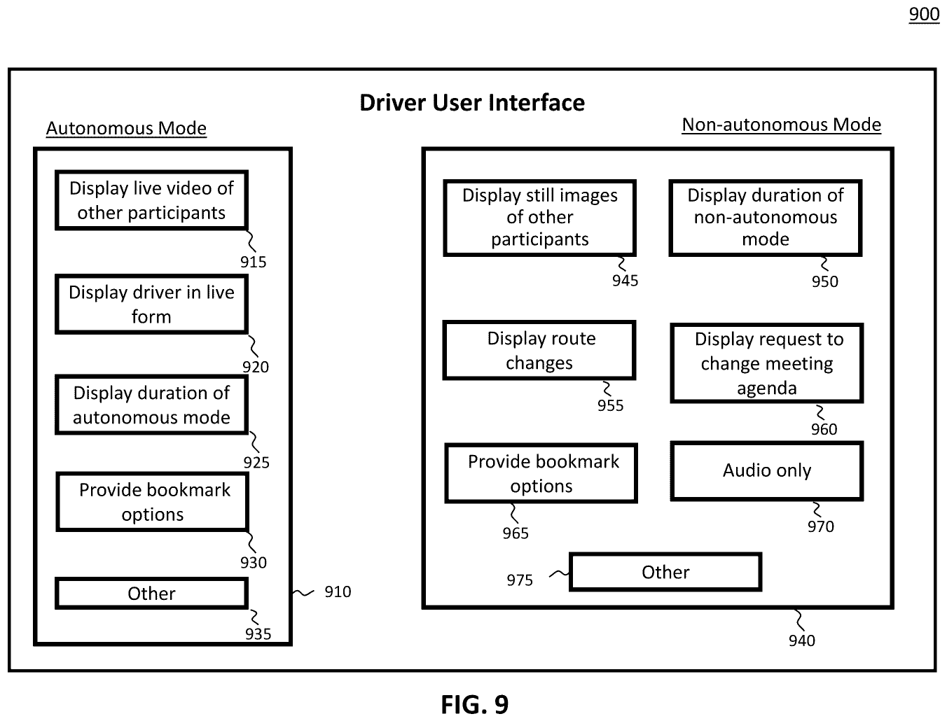

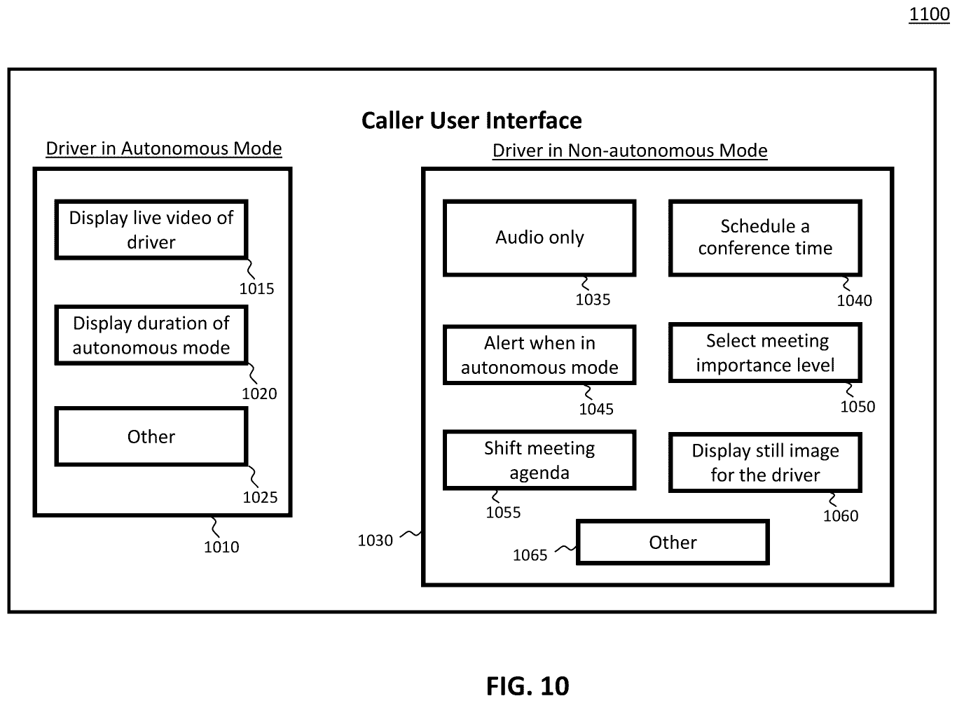

At block 103, in one embodiment, the control circuitry 220 and/or 228 may adapt the video conference user interface of either the conferencing UI in the driver conferencing device or the conferencing UI of all the other participants (who are not drivers) of the video conference call. In another embodiment, the control circuitry 220 and/or 228 may adapt the conference user interfaces of both the conferencing UI in the driver conferencing device and the conferencing UI of all the other participants (who are not drivers) of the video conference call. The adaptation may correspond to the mode of operation determined at block 102. Some examples of UI adaptations are further described in relation to FIGS. 9 and 10.

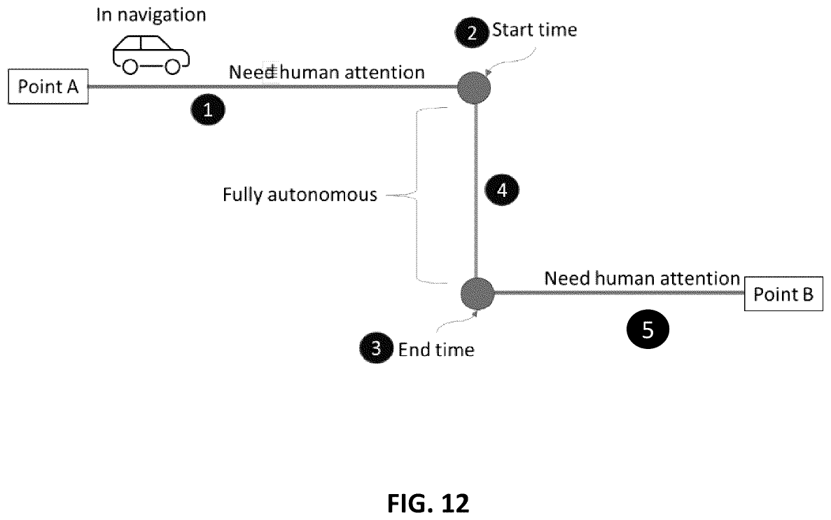

In one embodiment, a determination may be made at block 102 that the autonomous vehicle is currently operating in non-autonomous mode. The autonomous vehicle may be operating in the non-autonomous mode for a certain segment of the route, such as depicted in FIG. 12 as path 1, or the autonomous vehicle may be operating in the non-autonomous mode for the entire duration of the route.

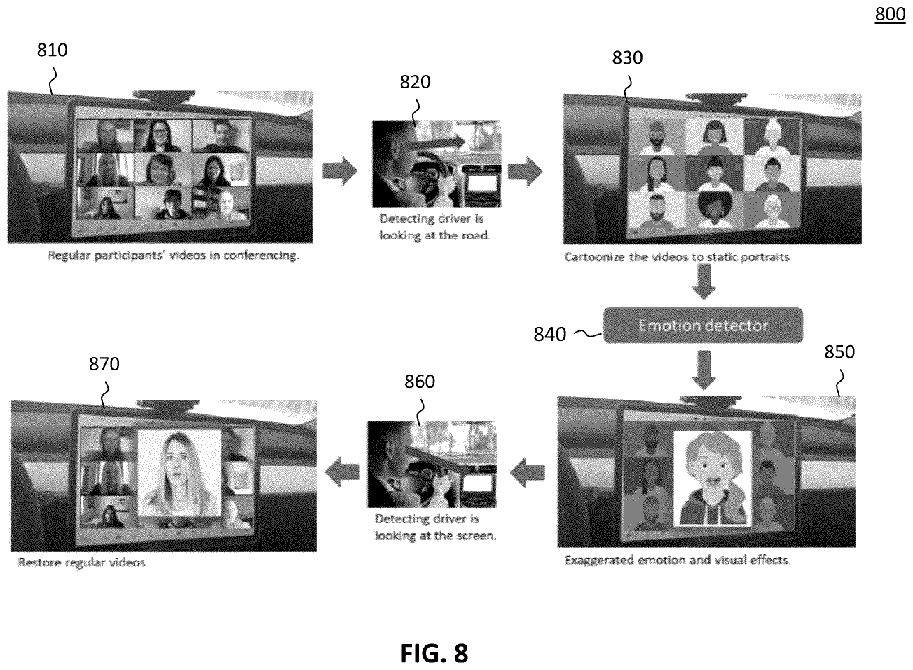

In one embodiment, when the driver is driving in the non-autonomous mode, i.e., manually driving the autonomous vehicle, then, due to safety reasons, it is preferred to let the driver focus on the road most of the time while still engaging in the video conference call that may be ongoing. In this embodiment, the driver does not see every change in participants' video feeds but may not need to, and the mode still allows the driver to notice major emotional changes in participants. Therefore, in one embodiment, as depicted as one of the UI adaptations at 830 in FIG. 8 or at 945 in FIG. 9, still images or photographs of other participants of the video conference call may be displayed instead of a real-time live video of the participants in the video conference call. As such, if the driver is looking at the road, the control circuitry 220 and/or 228 may disable the videos of the participants and replace them with still images. Replacing the video in the video conference on the conferencing UI of the driver conferencing device may reduce the visual perceptual load in video conferencing while driving. In other words, it may allow the driver to engage in the video conference without having to stare continuously at the videos of the participants.

In a typical video conference, most of the time, most participants will have relatively stable emotions; thus, there is nothing to look at in the live video of each participant. Since the participant motions and emotions are stable, the driver looking at the participant video while driving is unnecessary and may create a safety risk by diverting their attention from the road to the participant video displayed on the UI in the driver conferencing device. As such, the control circuitry 220 and/or 228 may disable participant video to hide all the small movements and details while the driver is driving the autonomous vehicle in non-autonomous mode. The disabled videos may be replaced with a still image or an icon in the place where the participant video is to be displayed on the screen of the UI in the driver conferencing device. In another embodiment, the control circuitry 220 and/or 228, instead of disabling participant video of all participants, may disable video of the non-speaking participants such that instead of seeing a gallery videos of all participants, only a single video of the speaking participant is displayed. In yet another embodiment, the system may monitor the gaze of the driver of the non-autonomous vehicle. When a determination is made that the driver of the non-autonomous vehicle is gazing at the UI, then either the still images or the single video of the speaking participant may be displayed. When a determination is made that the driver of the non-autonomous vehicle is not gazing at the UI, then a blank screen may be displayed.

Although the videos of the participants of the video conference call are not directly visible to the driver, the control circuitry may still stream the video content and process it in the background. This may include processing the videos of the participants, any screenshare performed during the video conference call including any documents or files presented, and audio from the video conference call.

In some embodiments, one of the back-end processes performed by the control circuitry 220 and/or 228 may be to activate an emotion detector. The emotion detector may obtain the video of each participant and detect if the change in emotion of any participant is above an emotion threshold. In other words, it may determine if the change in emotion is minimal, thereby relating to standard or relatively stable emotions as described above. For example, such standard or relatively stable emotions may relate to a participant nodding their head, gazing at the video conference call, or looking elsewhere on their computer to do some other work while simultaneously participating in the video conference call.

When such standard or relatively stable emotions are determined, the control circuitry, in some embodiments, may adapt the driver's conference UI to display a still image, an avatar, a photograph, or an icon. The still image may be, in some embodiments, a caricature or image of the participant. It may also be a cartoon of the participant, as depicted in FIG. 8. Accordingly, the control circuitry 220 and/or 228 may replace the video of each participant that is displayed on display of the driver's conference UI to display with the still image.

If there is something unusual during the video conference call, such as a participant disagreeing with what the speaker is presenting, the emotion from that particular participant will be detected by the emotion detector. Some of the typical emotions during a conference include agreement, question, doubt, confusion, etc. The emotions are usually detected using facial expressions together with certain movements or gestures. Such emotions may include nodding of head in a disagreeing manner, waving hands, scratching heads, rubbing eyes, etc. In this case, the driver might want to take a look at the video of the participant since it may be more than a standard or stable emotion or something that needs a deeper look since it potentially relates to an important point in the video conference. When such a change in emotion is detected, then the control circuitry 220 and/or 228 may replace the still image or cartoon with a live video of the participant. The control circuitry 220 and/or 228 may also perform additional enhancement of the video of the participant whose emotional change is above a threshold. These additional enhancements may include highlighting the video of the participant, enlarging the size of their video, blurring videos of all other participants. The control circuitry may also display an arrow pointing to such a participant.

In some embodiments, the control circuitry may allow the driver to take a quick look at the driver conference device's UI when an exaggerated emotion is detected. For example, the control circuitry may produce visual effects, such as a pop up on the UI of the driver's conferencing device, to attract the driver's attention from their peripheral vision. Once the driver is detected to be looking at the screen, the still image may be switched to real-time video immediately, as depicted at block 104.

As depicted at block 104, the control circuitry 220 and/or 228 may display a plurality of adaptations on conferencing UI in the driver conferencing device based on the autonomous vehicle's mode of operation determined at block 102. As the mode of operation switches, such as from autonomous to non-autonomous, or non-autonomous to autonomous, and continues to switch back and forth, the control circuitry 220 and/or 228 may also switch from still images to live video and back from live video to still images based on the corresponding changes in mode of operation. Likewise, even if the driver is driving in a non-autonomous mode, which may result in the control circuitry 220 and/or 228 displaying still images for all the participants of the video conference call on the conferencing UI in the driver conferencing device, if the driver switches their gaze, even for a short duration, towards the conferencing UI in the driver conferencing device, the control circuitry 220 and/or 228 may switch from a still image to a live video.

Additional UI adaptations, when the mode of operation of the vehicle is in non-autonomous mode for the conferencing UI in the driver conferencing device, are described further in relation to FIG. 9 below. Some of such adaptations include displaying duration of the non-autonomous mode, displaying alternative routes and ability to accept the route changes, a mode to request shifting of meeting agenda, and/or bookmarking the video conference call.

Referring back to block 101, in another embodiment, while the video conference call is in progress, and a request is received to add the driver to the call, a determination may be made at block 102 that the autonomous vehicle's current mode of operation is in an autonomous mode.

In some embodiments, the control circuitry 220 and/or 228 may access a computer system associated with the autonomous vehicle to determine whether the autonomous vehicle is being driven in the non-autonomous mode. In other embodiments, the control circuitry 220 and/or 228 may make the determination based on information published by the autonomous vehicle or a server associated with the autonomous vehicle.

As described earlier, autonomous mode or driving in an autonomous mode is a mode in which the vehicle is driven automatically or in self-driving state. The autonomous mode may include other driving situations in which the traffic density surrounding the autonomous vehicle is below a threshold, when the autonomous vehicle is driven in a rural area, when the autonomous vehicle is being driven at a certain time or day when the traffic is below a threshold, or when the autonomous vehicle is driven within a safety threshold.

Once the control circuitry 220 and/or 228 determines that the autonomous vehicle is being driven in an autonomous mode, the control circuitry 220 and/or 228 may associate such mode with requiring a lesser amount of driving attention from the driver, thereby allowing the driver additional options to engage in the video conference call currently in progress. Accordingly, the control circuitry 220 and/or 228 may perform one or more adaptations of the conferencing UI in the driver conferencing device as described in FIG. 9.

In some embodiments, one such adaptation may be to switch from a still image to a live video. For example, if still images of other participants are being currently displayed on the conferencing UI in the driver conferencing device, then, based on detecting that the autonomous vehicle is being driven in an autonomous mode, the control circuitry 220 and/or 228 may switch from still images of the participants to a live video of the participants. As the mode of operation switches, such as from autonomous to non-autonomous, the control circuitry 220 and/or 228 may also switch from live video of the participants to still images of the participants. Likewise, even if the driver is driving in the autonomous mode, which may result in the control circuitry 220 and/or 228 displaying live video of all the participants of the video conference, if the driver switches their gaze from the conferencing UI in the driver conferencing device to the road, e.g., glances away from the UI, then the control circuitry 220 and/or 228 may switch from the live video to the still images.

Based on the autonomous mode, in some embodiments, the control circuitry 220 and/or 228 may also perform one or more adaptations of the conferencing UI in the participants conferencing device that are non-drivers, as described in FIG. 10. For example, on the UI of the non-driving participants, the control circuitry 220 and/or 228 may display a live video of the driver, a display duration of autonomous mode, i.e., how much longer the autonomous mode may continue based on the route.

In a second embodiment, at block 101, a video conference call may be in a planning stage and not yet in progress. A participant of the video conference call may be desiring to schedule a call with a driver of an autonomous vehicle for an upcoming video conference call. As described earlier, the driver may be using a conferencing device, which may include a conferencing user interface (UI) for engaging in and displaying the video conference call at the scheduled time. The conferencing device may include, in non-limiting examples, a smartphone, a navigation system, a video conferencing device integrated into the vehicle such as in the dashboard area, a laptop or tablet that the user may mount at some location in the autonomous vehicle, or any other type of display device that is either a standalone device or is a device that can be partially or fully integrated into the autonomous vehicle.

When a video conferencing call is being scheduled, a calendar or conference scheduling tool may be used to send a meeting request to the driver of the autonomous vehicle. The meeting request (i.e., a video conference call request), similar to a typical conference call meeting request, may include the time and date of the scheduled video conference call, participants that are invited to join the scheduled video conference call, agenda of the video conference call, and files, such as slides or documents, that are to be shared in the video conference call.

When a video conference call is being scheduled, a server associated with the caller (who is the scheduler of the video conference call), or the video conferencing system, may analyze a plurality of factors to determine whether the video conference call should be scheduled. Since the driver of the autonomous vehicle, with whom the call is being scheduled, will be engaging in the video conferencing call while in the autonomous vehicle, the factors analyzed may relate to safety of the driver at the scheduled time of the video conference call. In other words, a determination may be made whether the driver will be driving the autonomous vehicle in autonomous or non-autonomous mode at the time when the call is being scheduled. If a determination is made that the call is to be scheduled, then another determination may be made as to which UI configurations to adapt at the time of the scheduled call.

In some embodiments, the determination of whether to schedule the video conference call may be based on the mode of operation of the autonomous vehicle at the scheduled time of the call. These modes of operations may include autonomous and non-autonomous driving modes, as described in block 102. The mode of operation may also include other modes described in block 102, such as a parked mode. Autonomous mode may include the vehicle being automatically driven by a computer associated with the car without driver intervention. Autonomous mode may also include the vehicle being operated below a threshold speed (also referred to as speed mode), in a rural area, at a certain low-traffic time of the day or week, or in a manner in which the safety risk is low.

Determining the mode of operation and the duration of that mode of operation may allow the control circuitry 220 and/or 228, at block 103, to adapt the conferencing UI in the driver conferencing device that corresponds to the mode of operation at the scheduled time of the video conference call. Adapting the UI based on the mode of operation would make it safer for the driver to engage on the video conference call while continuing in the current mode of operation of the autonomous vehicle. Some examples of UI adaptations are described further in relation to the description of FIGS. 9 and 10.

In some embodiments, the autonomous vehicle, or a server associated with the vehicle of the driver's conferencing device, may publish a current mode of operation and/or an anticipated mode of operation based on the vehicle's route, and other vehicle data as described in relation to FIG. 11. Such published data may be used in determining the anticipated mode of operation of the autonomous vehicle at the time of the scheduled call.

To publish such data, in some embodiments, control circuitry associated with autonomous vehicle, a server associated vehicle, or the driver's conferencing device may gather the data from one or more sources. These sources may include sensors, an onboard computer, a vehicle navigation system, and/or cameras associated with the autonomous vehicle. In some embodiments, a car location service may also be used to publish location data of the vehicle. The car location service may be associated with an account of the video conferencing system, such as Zoom™ account or username, Google Meet™ account or username, etc. The published or broadcasted data may be used to enable some of the adaptations of the UI for the video conference, such as adaptations discussed in relation to FIGS. 9 and 10.

In some embodiments, the server, conferencing device of the driver or participant, or the video conferencing system may receive the published data and determine a) whether a call is to be scheduled and b) if it is to be scheduled, a format that may be used during the call. For example, based on the published data, if a determination is made that the mode of operation when the call is to be conducted (i.e., based on the scheduled time) will be non-autonomous, then the UI adaptation for the driver's conferencing device may include still images of participants, audio only, and other adaptations displayed in FIG. 9. In another example, based on the published data, if a determination is made that the mode of operation when the call is to be conducted will be autonomous, then the UI adaptation for the driver's conferencing device may include live video of participants, display of the driver's face in real time, and other adaptations displayed in FIG. 9. Likewise, the control circuitry 220 and/or 228 may also configure different UI adaptations for the non-driver participant of the video conference call based on the autonomous vehicle's determined mode of operation. Some examples of such UI adaptations for non-driver participants are described in relation to FIG. 10.

As described earlier, the control circuitry 220 and/or 228 may access a source associated with the autonomous vehicle and then publish the information to be used for video call planning and scheduling purposes. In some embodiments, the publishing may be public, and in other embodiments, it may be private and may require permissions, such as device authorization of the participant's device, or it may be password-protected. In some embodiments, the control circuitry, such as control circuitry 220 and/or 228, may access the data from a source, such as the vehicle navigation system or cloud-based system, to determine the autonomous vehicle's route, such as the route depicted in FIG. 12. Based on the route determination, the control circuitry 220 and/or 228 may determine the segments of the route during which the autonomous vehicle's mode of operation may be associated with autonomous and non-autonomous modes. For example, in FIG. 12, segment or path 1 may require human attention during the driving of the autonomous vehicle. The human attention may be required for any number of reasons, such as dense traffic, several turns, terrain of the road, etc. Since segment 1 needs human attention, the autonomous vehicle may be driven in non-autonomous mode during segment 1. The control circuitry 220 and/or 228 may further determine the times during which the autonomous vehicle may be driven on path 1 as well as the duration of path 1. The control circuitry 220 and/or 228 may publish such data to be used for video call scheduling purpose.

The server, the conferencing device of the driver or participant, or the video conferencing system may receive the published or shared data and determine a) whether a call is to be scheduled and b) if it is to be scheduled, a format (e.g., audio, video, etc.) that may be used during the call. Based on the example above, during segment 1, when the car is being driven in a non-autonomous mode, the control circuitry may provide a notification to the participant who is scheduling the call. The notification may indicate that the autonomous vehicle will be in non-autonomous mode at the time the meeting is being scheduled. Accordingly, the control circuitry may provide one or more options to the participant scheduling the call. These options may include, for example, those listed in FIG. 10.

One example of adapting on the UI in the driver conferencing device may include adapting the UI based on the current mode of operation being a non-autonomous mode. In this example, if the video conferencing call is being scheduled for 10:15 a.m. on a Monday, the control circuitry 220 and/or 228 may determine whether the autonomous vehicle will be in an autonomous or a non-autonomous mode at 10:15 a.m. on Monday and for how long the autonomous vehicle will be in the autonomous or a non-autonomous mode thereafter. In other words, if the control circuitry 220 and/or 228 determines that at 10:15 a.m. Monday the autonomous vehicle will be in the autonomous mode, then the control circuitry 220 and/or 228 may determine whether the vehicle will be in the autonomous mode for 10 minutes, 15 minutes, the entire duration of the call, etc. If a determination is made that the autonomous vehicle will be in the autonomous mode for 20 minutes, and the duration of the 20 minutes falls within the time when the video call is being scheduled, then the control circuitry 220 and/or 228 may allow the call to be scheduled and configure the UI in the driver conferencing device to display autonomous mode features as described in FIG. 9 and configure the non-drivers' UI to display autonomous mode features as described in FIG. 10. However, if a determination is made that the autonomous vehicle will be in a non-autonomous mode at the time when the call is being scheduled, then the control circuitry 220 and/or 228 may configure a UI adaptation for non-autonomous mode as described in FIGS. 9 and 10.

Referring to FIG. 12, the autonomous to non-autonomous mode may change based on the route selected by the driver to their destination. If the route selected is that of FIG. 12, then segments 1 and 5 may be determined to be non-autonomous and segment 4 may be determined to be autonomous. As such, in terms of scheduling a video conference call, the control circuitry may determine during which segment of the route to configure a UI adaptation for the driver's conferencing device that aligns with the mode of operation. For example, the control circuitry 220 and/or 228 may configure a UI adaptation in which a still image and audio-only call is conducted during segment 1, then switch it to live video call during segment 4, and then switch it back to a UI adaptation in which a still image and audio-only call is conducted during segment 5. As such, the control circuitry 220 and/or 228 may continuously change the driver side UI adaptation to align with the mode of operation.

The control circuitry 220 and/or 228 may anticipate a mode of operation for the autonomous vehicle by accessing a plurality of sources associated with the driver. For example, the control circuitry 220 and/or 228 may access the driver's calendar to determine the driver's calendared appointments, events, and locations where the driver has scheduled to be at future times. The control circuitry 220 and/or 228 may also access work schedules, school schedules, and other routine schedules to determine which route the driver routinely takes every day and at what time. The control circuitry 220 and/or 228 may also access a driver's emails, documents shared, texts, social media posts, voice messages and other communications to determine the driver's future plans and whether the driver will be on the road to reach a certain destination. For example, the control circuitry 220 and/or 228 accessing a driver's calendar or another piece of communication, such as a text, may determine that the driver will leave work today at the usual time and then has to meet a friend at a restaurant across town. Analyzing the data, such as by using an artificial intelligence algorithm, the control circuitry 220 and/or 228 may determine that the driver will leave work at 5:00 p.m., determine the route to a restaurant, determine the traffic at that time, and determine segments of the route that may be autonomous and segments that may not be autonomous. Based on such data, in one embodiment, the control circuitry 220 and/or 228 may schedule the video conference call and configure the driver and non-driver side UI to align with the anticipated mode of operation. In another embodiment, based on the route data, the control circuitry 220 and/or 228 may a) either automatically initiate the video conference call with the driver's conferencing device, such as when the autonomous vehicle reaches an autonomous state, or b) provide an alert or an option to the driver to select the automatic joining option and upon selectin of such an option automatically initiate the video conference call with the driver's conferencing device.

In yet another embodiment, if an invitation for joining the video conference call was already transmitted by the caller device, and then a determination is made that the driver is currently driving the autonomous vehicle manually, i.e., the state of the autonomous vehicle is in a non-autonomous state, then the invitation may be cancelled. Furthermore, the user interface of the caller may be configured to provide an option to automatically initiate (also referred to as auto-initiate) the video conference call with the driver when the autonomous vehicle reaches an autonomous state. When auto-initiation occurs, i.e., when the driver's device is to about to be connected automatically to the video conference call, an alert may be transmitted to the driver's device as well as the caller's device. The alert to the driver's device may notify the driver that the video conference call is being automatically initiated. Such an alert may provide the driver privacy options to accept, deny, or allow the call in a blurred more, or change to an audio call etc. The alert may also allow the driver to get ready to receive the call. The alert to the caller's device may notify the caller that the video conference call is being automatically initiated and that the driver will be joining. Since the caller may be doing other things after selecting auto-initiation, such an alert may give a heads-up to the caller to now focus on the call or get ready for the call.

On the driver end, in one embodiment, an invitation for joining the video conference call may be received and the system may determine that the autonomous vehicle is currently being driven in a non-autonomous state. Accordingly, the user interface of the driver's conferencing device may be dynamically configured such that the driver of the autonomous vehicle can only accept the invitation to join the conference call in an audio only mode, and not in a video mode.

Referring back to FIG. 1, at block 105, once a video conference call is in progress, the control circuitry 220 and/or 228 may present bookmarking options via the conferencing UI in the driver conferencing device. The bookmarking options may allow the driver to bookmark a point in the video conference such that if the driver misses a portion in the video conference due to a distraction or due to having to manually drive the autonomous vehicle, the driver can, at a later time, go back to the missed portion based on the bookmark.

In some embodiments, even though the driver can participate in the video conference call, the required level of attention could change at any moment. For example, in fully autonomous mode, the driver may be looking at a presentation slide on the UI in the driver conferencing device. Then suddenly, the autonomous vehicle may detect a change in traffic or weather conditions that may require braking, paying additional attention, etc. As such, the autonomous mode may be disabled, and the autonomous vehicle may alert the driver to take manual control of the autonomous vehicle. Assuming the video conference call is being recorded, the UI in the driver conferencing device may be configured to allow the driver to add a bookmark. The bookmark may include a snapshot or a recording of the driver or the driver's surroundings. The bookmark may be used as a reminder of the point in the video conference when the driver's attention was diverted. Such surroundings used for a bookmark may include a snapshot of the road, snapshot of the driver, bookmark relating to the location on the road, such as on Highway 101 near the Lawrence exit, bookmark relating to a landmark, such as next to XYZ restaurant, XYZ building, Eiffel Tower, etc. The bookmark may also be a snapshot of a document or presentation being presented on the video conference call at the time of bookmarking. The bookmark may also be a snapshot of the navigation map or a picture of all passengers in the car.

In some embodiments, when a switch from an autonomous mode to non-autonomous mode is made, the control circuitry may automatically notify the conference device used by the driver to generate a bookmark and associate it with a timestamp in the video conference call. For example, the control circuitry may take a screenshot of the surroundings of the driver or the autonomous vehicle and save it as a bookmark. If there is a presentation or document being displayed on the UI in the driver conferencing device, the control circuitry may associate the bookmark with a corresponding point in time in the video conference when a page of the document or a slide of the presentation was presented. The bookmark may then be stored with the recording of the video conference call and be retrieved to remind the driver where they have left off.

In some embodiments, if the driver has to keep their eye on the road, i.e., the autonomous vehicle is being driven on a road that requires non-autonomous driving, then the driver can insert a bookmark via a button, hand gesture, wake word, etc. Since the current mode of operation at the time would be associated with non-autonomous mode, a bookmark, such as a snapshot of the current street view, will help the driver visualize that bookmark moment. If the video conference call is being recorded, the driver can bookmark or tag certain moments to review later. These tags may be inserted in the stored copy of the recording of the video conference call that the driver retrieves later.

The recordings of the video conference may include, the recording of the video conference, any interaction of the driver, either with the road or the video conference, any display of content during the video conference, and any tags or bookmarks inserted to the video conference call. The recording may be a newly generated copy that may be for the driver only or it may be saved as an amended recording to the cloud for all participants to view.

In some embodiments, the driver may tag portions of the video conference call via a voice command-such as “tag this” or “tag slide” or “tag presenter.” Doing so may produce a personalized version of the recording of the video conference call for the driver. In some embodiments, the tagging feature may be available only to the driver of the autonomous vehicle. In other embodiments, the tagging feature may be available to any participant of the video conference call. For example, participants of the video conference call may tag portions of the meeting during which someone presented a video or a PowerPoint slide. These tags, which are bookmarks, may be automatically inserted into the recorded version of the video conference call. In some embodiments, each participant may be allowed to tag only their portion of the recording, and in other embodiments, a participant may be allowed to tag sections for other participants of the video conference call. For example, a manager may tag a slide or section of a meeting to a subordinate (similar to assigning a task) as well as insert comments into the recording without interrupting the video conference call. Such comments may be made part of the auto-generated transcripts (e.g., labeled as comments).

In some embodiments, the driver of the autonomous vehicle may utter a wake word or a voice command to bookmark a specific point in the video conference call. The control circuitry may analyze the speech uttered by the driver to distinguish between the speech being associated with the driver's participation in the video conference call and the speech being associated with a voice command or wake word. For example, if the driver utters the word bookmark, the control circuitry may analyze the context of the word to determine whether it was intended to bookmark a point in the video conference call, or the driver was speaking or responding to someone in the video conference call. For example, if the wake word is uttered out of context from what is being discussed in the video conference call, then the control circuitry may determine that the wake word is not meant to be heard by others and is for the purposes of bookmarking a point in the video conference call. When a determination is made that the wake word related to bookmarking a point in the video conference call, the control circuitry may mute the wake word such that other participants of the video conference call may not hear the utterance of the wake word. The control circuitry may do so by buffering a delay in the speech uttered by the driver and transmitting the speech to the other participants. The buffered delay may allow the control circuitry to remove utterances of voice commands and wake words and concatenate any gaps in speech to give the perception of continuous speech to the other participants.

At block 106, in some embodiments, the control circuitry 220 and/or 228 may provide rerouting options. The rerouting options may be presented based on a request of any participant of the video conferencing call or the driver, or they may be automatically presented based on recommendations from an AI engine executing an AI algorithm.

In some embodiments, an indication of the importance of the video conference call will be delivered to the autonomous vehicle, a server associated vehicle, or the driver's conferencing device. For example, the video conferencing call may be associated with different levels or importance ranging from 1-10, from low to high, or some other scale that may be used to determine the level of the video call's importance. In other embodiments, the importance of the video conferencing call may be determined based on the participants of the call, e.g., a senior level manager, CEO or boss being a participant or presenter may be associated with a higher level of importance than a call that has other same-level colleagues. The importance of the video conferencing call may also be determined based on the content and context of the call. For example, a routine weekly meeting may not be as important as an annual performance review. The importance of the call may also be determined based on the indicators in an email distributed, such as marked urgent, important, etc.

In some embodiments, based on the importance indicators as described above, or content, context, type of participants, nature of call, types of documents attached to the invite, and other factors, the control circuitry may automatically determine the importance level of the call. In other embodiments, the participants or the driver may assign an importance to a scheduled video conference call.

In some embodiments, depending on the importance of the call, the autonomous vehicle may automatically select a fully autonomous segment of the trip, even if that route is less optimal in trip distance or other criteria. Alternatively, the autonomous vehicle may, via the autonomous vehicle's navigation system or the driver's conferencing device UI, suggest alternative routes or the nearest parking location for the driver to join the call.

In one example, as depicted in block 106, the destination to a specific location, such as home, workplace, event, etc., may include two routes, route 1 and route 2. As depicted, route 1 may include four sequential segments to get to the final destination. These segments may include segment 1, during which the autonomous vehicle may be driven in autonomous mode for 12 minutes; segment 2, during which the autonomous vehicle may be driven in non-autonomous mode for 7 minutes; segment 3, during which the autonomous vehicle may be driven in autonomous mode for 11 minutes; and segment 4, during which the autonomous vehicle may be driven in autonomous mode for 17 minutes. As such, a total of 40 minutes (12+11+17 minutes) may be driven in an autonomous mode using route 1. Likewise, route 2 may include a total of 30 minutes of autonomous driving to the final destination.

In one embodiment, based on the length of the video conference call, the control circuitry 220 and/or 228 may determine which route to select or suggest to the driver. For example, if the call is important and length of the call is longer that 30 minutes, then the control circuitry 220 and/or 228 may suggest route 1 instead of route 2, since route 1 has a longer total autonomous time that allows the driver to visually focus on the video conference call for a longer period than if route 2 were taken.

In another embodiment, the control circuitry 220 and/or 228 may determine which route to select or suggest to the driver based on the time of the video conference call. For example, a call may be important, and it may be scheduled for 30 minutes. If route 1 is taken, based on the scheduled time of the call, the call may start when the driver is in segment 2, which allows for 7 minutes of non-autonomous driving followed by segments 3 and 4, which allow for 28 minutes of autonomous driving. As such, if this route (route 1) is taken the driver may miss the first 7 minutes of the 30-minute call and then be able to focus on the rest of the call as it falls within the autonomous driving more. If route 2 were taken, based on the scheduled time of the call, the call may start when the driver is in segment 2 of route 2, which allows for 19 minutes of non-autonomous driving followed by segment 3, which allow for 27 minutes of autonomous driving. As such, if this route (route 2) is taken the driver may miss the first 19 minutes of the 30-minute call and then be able to focus on the rest of the call as it falls within the autonomous driving more. Accordingly, the control circuitry may determine how much of a call will the driver miss, i.e., have to attend in non-autonomous mode, and based on such analysis may suggest which route to take. Since the driver would miss more of a call if route 2 were taken (i.e., miss 7 minutes of the call when driving on in route 1 and 19 minutes of call when driving on route 2), the control circuitry may suggest route 1 as a better alternative.

Other factors besides length of the call and timing of the call may also be considered in suggesting a route for the autonomous vehicle. For example, based on the agenda of the video conference call, a determination may be made that an important portion of the video conference call is when participant 2 will be presenting the result of an analysis. The control circuitry may determine, based on the agenda of the video conference call, that participant 2 is to schedule to speak for five minutes and his speaking time starts 15 minutes after the start of the video conference call. Accordingly, the control circuitry 220 and/or 228 may determine which route allows the autonomous vehicle to be driven in fully autonomous mode during the five-minute segment allotted to participant 2 and select such a route.

In some embodiments, a predetermined value or threshold may be set for an importance level of the video conference call. An importance level determination of the call may be made and compared to the threshold importance level. If the importance level associated with the video conference call exceeds the predetermined threshold level, then the control circuitry may automatically suggest the alternative route options.

FIG. 2 is a block diagram of an example system for determining a mode of operation of an autonomous vehicle, adapting a user interface based on the mode of operation, and providing conferencing tools, in accordance with some embodiments of the disclosure. FIGS. 2 and 3 also describe example devices, systems, servers, and related hardware that may be used to implement processes, execute user interface operations, and all other steps, functions and functionalities described at least in relation to FIGS. 1, 4-19. Further, FIGS. 2 and 3 may also be used for determining whether a video conference call is being scheduled or already in progress, determining that a video conferencing device is located inside an autonomous vehicle, determining that the video conferencing device is integrated into the autonomous vehicle, determining that the video conferencing device uses a video conferencing application that is native to the autonomous vehicle, determining whether a driver or a passenger of the autonomous vehicle is engaged or engaging in the video conference call, determine which user profile was used for operating the autonomous vehicle, determining which user profile was used to engage in the video conference call, matching user profiles associated with autonomous vehicle and video conferencing account, determining the mode of operation of an autonomous vehicle, determining that the mode is autonomous, determining that the mode is non-autonomous, determining other modes of operation, such as speed mode, safety mode, environmental mode, time-based mode, and parked mode, determining adaptations for driver's user interface and caller's user interface, determining which set of functionalities to dynamically configure for the driver and caller's user interfaces based on the autonomous vehicle's mode of operation, changing adaptations from still image to live video and live video to still mage based on the autonomous status of the autonomous vehicle, providing bookmarking options, providing routing options, changing routes based on importance of a call, selecting routes based on being able to drive on autonomous segments during the duration of the video conference call, in a multi-user scenario where multiple users associated with multiple conferencing devices are located in a car, determining which device is associated with the driver and which device is associated with the passenger and accordingly configuring adaptations, utilizing AI and ML algorithms, and performing functions related to all other processes and features described herein.

In some embodiments, one or more parts of, or the entirety of system 200, may be configured as a system implementing various features, processes, functionalities and components of FIGS. 1, 5-8 and 18. Although FIG. 2 shows a certain number of components, in various examples, system 200 may include fewer than the illustrated number of components and/or multiples of one or more of the illustrated number of components.

System 200 is shown to include a computing device 218, a server 202 and a communication network 214. It is understood that while a single instance of a component may be shown and described relative to FIG. 2, additional instances of the component may be employed. For example, server 202 may include, or may be incorporated in, more than one server. Similarly, communication network 214 may include, or may be incorporated in, more than one communication network. Server 202 is shown communicatively coupled to computing device 218 through communication network 214. While not shown in FIG. 2, server 202 may be directly communicatively coupled to computing device 218, for example, in a system absent or bypassing communication network 214.

Communication network 214 may comprise one or more network systems, such as, without limitation, an internet, LAN, WIFI or other network systems suitable for audio processing applications. In some embodiments, system 200 excludes server 202, and functionality that would otherwise be implemented by server 202 is instead implemented by other components of system 200, such as one or more components of communication network 214. In still other embodiments, server 202 works in conjunction with one or more components of communication network 214 to implement certain functionality described herein in a distributed or cooperative manner. Similarly, in some embodiments, system 200 excludes computing device 218, and functionality that would otherwise be implemented by computing device 218 is instead implemented by other components of system 200, such as one or more components of communication network 214 or server 202 or a combination. In still other embodiments, computing device 218 works in conjunction with one or more components of communication network 214 or server 202 to implement certain functionality described herein in a distributed or cooperative manner.

Computing device 218 includes control circuitry 228, display 234 and input circuitry 216. Control circuitry 228 in turn includes transceiver circuitry 262, storage 238 and processing circuitry 240. In some embodiments, computing device 218 or control circuitry 228 may be configured as electronic device 300 of FIG. 3.

Server 202 includes control circuitry 220 and storage 224. Each of storages 224 and 238 may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 4D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each storage 224, 238 may be used to store various types of content (e.g., information relating to video conference call status (ongoing or scheduled), location of video conferencing devices, profiles of the user associated with autonomous vehicle, profiles of the user associated with video conferencing accounts, mode of operation of an autonomous vehicle, user interface adaptations for driver's user interface when autonomous vehicle is autonomous state and in non-autonomous state, user interface adaptations for non-driver's user interface when autonomous vehicle is autonomous state and in non-autonomous state, still images, icons, avatars, and photographs for participants of the video conference call, bookmarking options, bookmarks made during the video conference call, information relating to routes and their autonomous and non-autonomous segments, and AI and ML algorithms). Non-volatile memory may also be used (e.g., to launch a boot-up routine, launch an app, render an app, and other instructions). Cloud-based storage may be used to supplement storages 224, 238 or instead of storages 224, 238. In some embodiments, data relating to video conference call status (ongoing or scheduled), location of video conferencing devices, profiles of the user associated with autonomous vehicle, profiles of the user associated with video conferencing accounts, mode of operation of an autonomous vehicle, user interface adaptations for driver's user interface when autonomous vehicle is autonomous state and in non-autonomous state, user interface adaptations for non-driver's user interface when autonomous vehicle is autonomous state and in non-autonomous state, still images, icons, avatars, and photographs for participants of the video conference call, bookmarking options, bookmarks made during the video conference call, information relating to routes and their autonomous and non-autonomous segments, and AI and ML algorithms, and data relating to all other processes and features described herein, may be recorded and stored in one or more of storages 212, 238.

In some embodiments, control circuitry 220 and/or 228 executes instructions for an application stored in memory (e.g., storage 224 and/or storage 238). Specifically, control circuitry 220 and/or 228 may be instructed by the application to perform the functions discussed herein. In some implementations, any action performed by control circuitry 220 and/or 228 may be based on instructions received from the application. For example, the application may be implemented as software or a set of executable instructions that may be stored in storage 224 and/or 238 and executed by control circuitry 220 and/or 228. In some embodiments, the application may be a client/server application where only a client application resides on computing device 218, and a server application resides on server 202.

The application may be implemented using any suitable architecture. For example, it may be a stand-alone application wholly implemented on computing device 218. In such an approach, instructions for the application are stored locally (e.g., in storage 238), and data for use by the application is downloaded on a periodic basis (e.g., from an out-of-band feed, from an internet resource, or using another suitable approach). Control circuitry 228 may retrieve instructions for the application from storage 238 and process the instructions to perform the functionality described herein. Based on the processed instructions, control circuitry 228 may determine a type of action to perform in response to input received from input circuitry 216 or from communication network 214. For example, in response to determining that the autonomous vehicle is being driven in a non-autonomous mode, deactivate a live video of the participants of the video conference call and replacing it their live feed with an icon, avatar, or image, or in response to determining that the autonomous vehicle is being driven in a non-autonomous mode allowing the video conference call for the driver to be in an audio only mode. It may also perform steps of processes described in FIGS. 1, 5-8 and 18, including determining whether the mode of operation of an autonomous vehicle is in an autonomous or non-autonomous mode such that the user interfaces of the driver's conferencing device and the non-driver's conferencing device may be dynamically configured to different adaptation corresponding to the mode of operation.

In client/server-based embodiments, control circuitry 228 may include communication circuitry suitable for communicating with an application server (e.g., server 202) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the internet or any other suitable communication networks or paths (e.g., communication network 214). In another example of a client/server-based application, control circuitry 228 runs a web browser that interprets web pages provided by a remote server (e.g., server 202). For example, the remote server may store the instructions for the application in a storage device. The remote server may process the stored instructions using circuitry (e.g., control circuitry 228) and/or generate displays. Computing device 218 may receive the displays generated by the remote server and may display the content of the displays locally via display 234. This way, the processing of the instructions is performed remotely (e.g., by server 202) while the resulting displays, such as the display windows described elsewhere herein, are provided locally on computing device 218. Computing device 218 may receive inputs from the user via input circuitry 216 and transmit those inputs to the remote server for processing and generating the corresponding displays. Alternatively, computing device 218 may receive inputs from the user via input circuitry 216 and process and display the received inputs locally, by control circuitry 228 and display 234, respectively.

Server 202 and computing device 218 may transmit and receive content and data such as profiles of the user associated with video conferencing accounts and modes of operation of an autonomous vehicle. Control circuitry 220, 228 may send and receive commands, requests, and other suitable data through communication network 214 using transceiver circuitry 260, 262, respectively. Control circuitry 220, 228 may communicate directly with each other using transceiver circuits 260, 262, respectively, avoiding communication network 214.

It is understood that computing device 218 is not limited to the embodiments and methods shown and described herein. In nonlimiting examples, computing device 218 may be an electronic device, a personal computer (PC), a laptop computer, a tablet computer, a WebTV box, a personal computer television (PC/TV), a PC media server, a PC media center, a handheld computer, a mobile telephone, a smartphone, or a device that can perform function in the metaverse, or any other device, computing equipment, or wireless device, and/or combination of the same capable of suitably determining all the functions described herein, such as determining mode of operation of the autonomous vehicle. Control circuitry 220 and/or 218 may be based on any suitable processing circuitry such as processing circuitry 226 and/or 240, respectively. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors, for example, multiple of the same type of processors (e.g., two Intel Core i9 processors) or multiple different processors (e.g., an Intel Core i7 processor and an Intel Core i9 processor). In some embodiments, control circuitry 220 and/or control circuitry 218 is configured for determining whether a video conference call is being scheduled or already in progress, determining that a video conferencing device is located inside an autonomous vehicle, determining that the video conferencing device is integrated into the autonomous vehicle, determining that the video conferencing device uses a video conferencing application that is native to the autonomous vehicle, determining whether a driver or a passenger of the autonomous vehicle is engaged or engaging in the video conference call, determine which user profile was used for operating the autonomous vehicle, determining which user profile was used to engage in the video conference call, matching user profiles associated with autonomous vehicle and video conferencing account, determining the mode of operation of an autonomous vehicle, determining that the mode is autonomous, determining that the mode is non-autonomous, determining other modes of operation, such as speed mode, safety mode, environmental mode, time-based mode, and parked mode, determining adaptations for driver's user interface and caller's user interface, determining which set of functionalities to dynamically configure for the driver and caller's user interfaces based on the autonomous vehicle's mode of operation, changing adaptations from still image to live video and live video to still mage based on the autonomous status of the autonomous vehicle, providing bookmarking options, providing routing options, changing routes based on importance of a call, selecting routes based on being able to drive on autonomous segments during the duration of the video conference call, in a multi-user scenario where multiple users associated with multiple conferencing devices are located in a car, determining which device is associated with the driver and which device is associated with the passenger and accordingly configuring adaptations, utilizing AI and ML algorithms, and performing functions related to all other processes and features described herein.

Transmission of user input 204 to computing device 218 may be accomplished using a wired connection, such as an audio cable, USB cable, ethernet cable or the like attached to a corresponding input port at a local device, or may be accomplished using a wireless connection, such as Bluetooth, Wi-Fi, WiMAX, GSM, UTMS, CDMA, TDMA, 3G, 4G, 4G LTE, 5G, 5G sidelink (5G NRV2X), 6G, or any other suitable wireless transmission protocol. Input circuitry 216 may comprise a physical input port such as a 3.5 mm audio jack, RCA audio jack, USB port, ethernet port, or any other suitable connection for receiving audio over a wired connection or may comprise a wireless receiver configured to receive data via Bluetooth, Wi-Fi, WiMAX, GSM, UTMS, CDMA, TDMA, 3G, 4G, 4G LTE, or other wireless transmission protocols.

Processing circuitry 240 may receive input 204 from input circuitry 216. Processing circuitry 240 may convert or translate the received user input 204 that may be in the form of voice input into a microphone. In some embodiments, input circuitry 216 performs the translation to digital signals. In some embodiments, processing circuitry 240 (or processing circuitry 226, as the case may be) carries out disclosed processes and methods. For example, processing circuitry 240 or processing circuitry 226 may perform processes as described in FIGS. 1, 5-8 and 18, respectively.

FIG. 3 is a block diagram of a conferencing device used for joining a video conference and displaying conferencing tools, in accordance with some embodiments of the disclosure. In some embodiments, the equipment device 300, is the same equipment device 202 of FIG. 2. The equipment device 300 may receive content and data via input/output (I/O) path 302. The I/O path 302 may provide audio content (e.g., such as in the speakers associated with the autonomous vehicle). The control circuitry 304 may be used to send and receive commands, requests, and other suitable data using the I/O path 302. The I/O path 302 may connect the control circuitry 304 (and specifically the processing circuitry 306) to one or more communications paths or links (e.g., via a network interface), any one or more of which may be wired or wireless in nature. Messages and information described herein as being received by the equipment device 300 may be received via such wired or wireless communication paths. I/O functions may be provided by one or more of these communications paths or intermediary nodes but are shown as a single path in FIG. 3 to avoid overcomplicating the drawing.

The control circuitry 304 may be based on any suitable processing circuitry such as the processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 or i9 processor). In client-server-based embodiments, the control circuitry 304 may include communications circuitry suitable for determining whether a video conference call is being scheduled or already in progress, determining that a video conferencing device is located inside an autonomous vehicle, determining that the video conferencing device is integrated into the autonomous vehicle, determining that the video conferencing device uses a video conferencing application that is native to the autonomous vehicle, determining whether a driver or a passenger of the autonomous vehicle is engaged or engaging in the video conference call, determine which user profile was used for operating the autonomous vehicle, determining which user profile was used to engage in the video conference call, matching user profiles associated with autonomous vehicle and video conferencing account, determining the mode of operation of an autonomous vehicle, determining that the mode is autonomous, determining that the mode is non-autonomous, determining other modes of operation, such as speed mode, safety mode, environmental mode, time-based mode, and parked mode, determining adaptations for driver's user interface and caller's user interface, determining which set of functionalities to dynamically configure for the driver and caller's user interfaces based on the autonomous vehicle's mode of operation, changing adaptations from still image to live video and live video to still mage based on the autonomous status of the autonomous vehicle, providing bookmarking options, providing routing options, changing routes based on importance of a call, selecting routes based on being able to drive on autonomous segments during the duration of the video conference call, in a multi-user scenario where multiple users associated with multiple conferencing devices are located in a car, determining which device is associated with the driver and which device is associated with the passenger and accordingly configuring adaptations, utilizing AI and ML algorithms, and performing functions related to all other processes and features described herein.

The instructions for carrying out the above-mentioned functionality may be stored on one or more servers. Communications circuitry may include a cable modem, an integrated service digital network (ISDN) modem, a digital subscriber line (DSL) modem, a telephone modem, ethernet card, or a wireless modem for communications with other equipment, or any other suitable communications circuitry. Such communications may involve the internet or any other suitable communications networks or paths. In addition, communications circuitry may include circuitry that enables peer-to-peer communication of primary equipment devices, or communication of primary equipment devices in locations remote from each other (described in more detail below).

Memory may be an electronic storage device provided as the storage 308 that is part of the control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid-state devices, quantum-storage devices, gaming consoles, gaming media, or any other suitable fixed or removable storage devices, and/or any combination of the same. The storage 308 may be used to store various types of content, (e.g., information relating to video conference call status (ongoing or scheduled), location of video conferencing devices, profiles of the user associated with autonomous vehicle, profiles of the user associated with video conferencing accounts, mode of operation of an autonomous vehicle, ser interface adaptations for driver's user interface when autonomous vehicle is autonomous state and in non-autonomous state, user interface adaptations for non-driver's user interface when autonomous vehicle is autonomous state and in non-autonomous state, still images, icons, avatars, and photographs for participants of the video conference call, bookmarking options, bookmarks made during the video conference call, information relating to routes and their autonomous and non-autonomous segments, and AI and ML algorithms). Cloud-based storage, described in relation to FIG. 3, may be used to supplement the storage 308 or instead of the storage 308.

The control circuitry 304 may include audio generating circuitry and tuning circuitry, such as one or more analog tuners, audio generation circuitry, filters or any other suitable tuning or audio circuits or combinations of such circuits. The control circuitry 304 may also include scaler circuitry for upconverting and down converting content into the preferred output format of the electronic device 300. The control circuitry 304 may also include digital-to-analog converter circuitry and analog-to-digital converter circuitry for converting between digital and analog signals. The tuning and encoding circuitry may be used by the electronic device 300 to receive and to display, to play, or to record content. The circuitry described herein, including, for example, the tuning, audio generating, encoding, decoding, encrypting, decrypting, scaler, and analog/digital circuitry, may be implemented using software running on one or more general purpose or specialized processors. If the storage 308 is provided as a separate device from the electronic device 300, the tuning and encoding circuitry (including multiple tuners) may be associated with the storage 308.

The user may utter instructions to the control circuitry 304, which are received by the microphone 316. The microphone 316 may be any microphone (or microphones) capable of detecting human speech. The microphone 316 is connected to the processing circuitry 306 to transmit detected voice commands and other speech thereto for processing. In some embodiments, voice assistants (e.g., Siri, Alexa, Google Home and similar such voice assistants) receive and process the voice commands and other speech.

The electronic device 300 may include an interface 310. The interface 310 may be any suitable user interface, such as a remote control, mouse, trackball, keypad, keyboard, touchscreen, touchpad, stylus input, joystick, or other user input interfaces. A display 312 may be provided as a stand-alone device or integrated with other elements of the electronic device 300. For example, the display 312 may be a touchscreen or touch-sensitive display. In such circumstances, the interface 310 may be integrated with or combined with the microphone 316. When the interface 310 is configured with a screen, such a screen may be one or more monitors, a television, a liquid crystal display (LCD) for a mobile device, active-matrix display, cathode-ray tube display, light-emitting diode display, organic light-emitting diode display, quantum-dot display, or any other suitable equipment for displaying visual images. In some embodiments, the interface 310 may be HDTV-capable. In some embodiments, the display 312 may be a 3D display. The speaker (or speakers) 314 may be provided as integrated with other elements of electronic device 300 or may be a stand-alone unit. In some embodiments, the display 312 may be outputted through speaker 314.

The equipment device 300 of FIG. 3 can be implemented in system 200 of FIG. 2 as primary equipment device 202, but any other type of user equipment suitable for allowing communications between two separate user devices for performing the functions related to implementing machine learning (ML) and artificial intelligence (AI) algorithms, and all the functionalities discussed associated with the figures mentioned in this application.

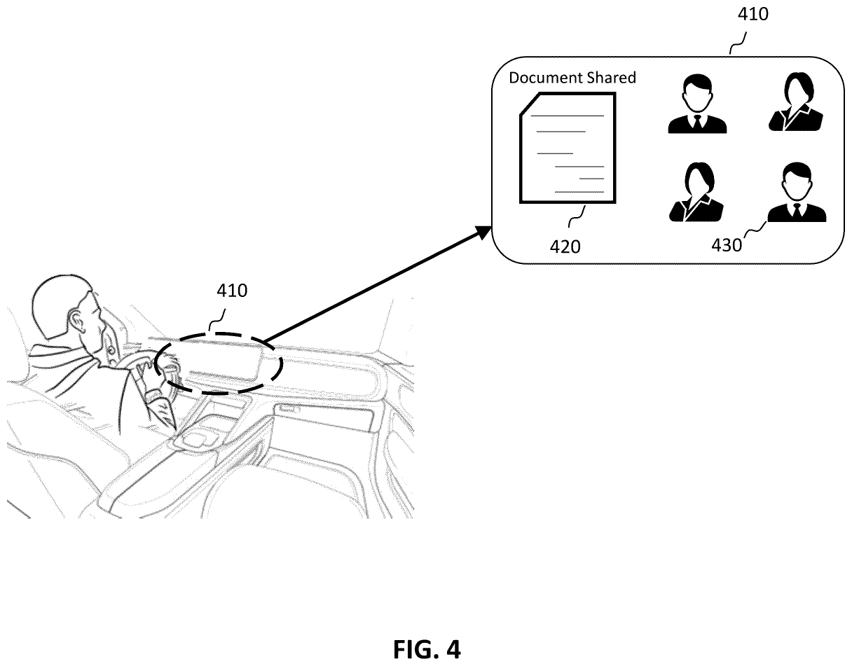

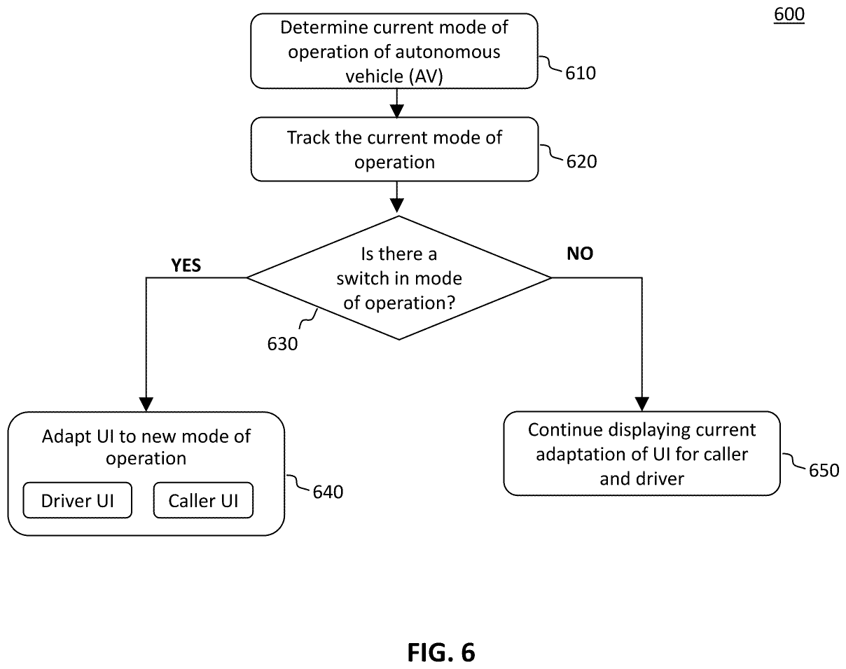

FIG. 4 is an example of a driver's conferencing device integrated into an autonomous vehicle, in accordance with some embodiments of the disclosure. The driver's conferencing device may include a user interface 410 that is used by the driver to engage in the video conference call. The user interface 410 may be used to display the video conference, including any documents 420 shared during the video conference, and participants 430 of the video conference. The various adaptations described herein, including adaptations referred to in blocks 104-105 of FIG. 1, block 640-650 of FIG. 6, FIGS. 8-10, and FIGS. 13-18, may be configured on UI 410 of the driver's conferencing device.

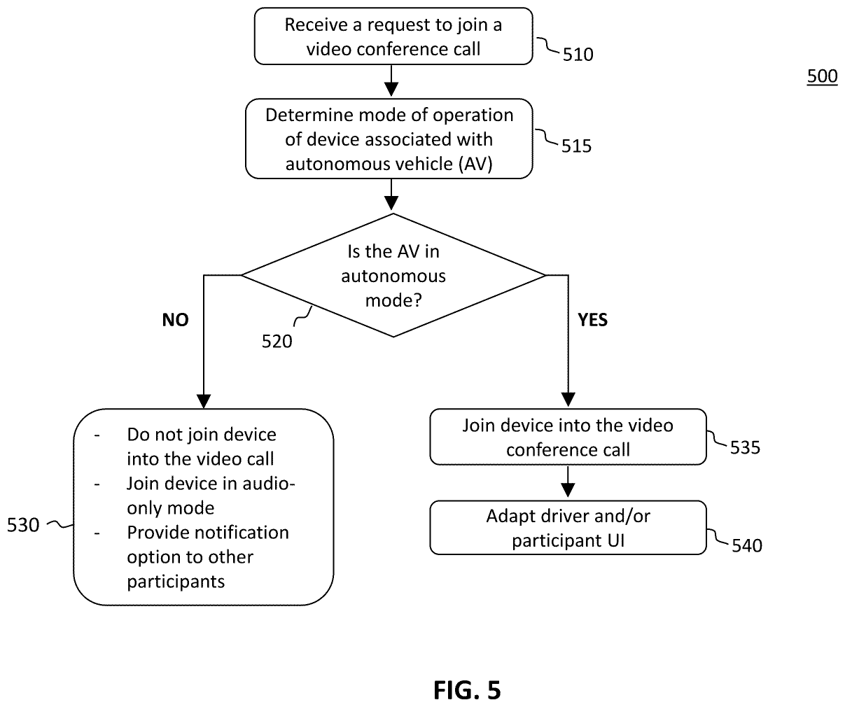

FIG. 5 is a flowchart of a process 500 of planning a conference call in which a driver of an autonomous vehicle would be a participant and adapting conferencing user interface based on the mode of operation of the autonomous vehicle, in accordance with some embodiments of the disclosure.

The process 500 may be implemented, in whole or in part, by systems or devices such as those shown in FIGS. 2 and 3. One or more actions of the process 500 may be incorporated into or combined with one or more actions of any other process or embodiments described herein. The process 500 may be saved to a memory or storage (e.g., any one of those depicted in FIGS. 2 and 3) as one or more instructions or routines that may be executed by a corresponding device or system to implement the method 500.

In some embodiments, at block 510, control circuitry, such as control circuitry 220 and/or 228 of FIG. 2, may receive a join request for a video conference call. The request may be directed to a driver of an autonomous vehicle, and it may be for an ongoing video conference call or a video conference call that is to be scheduled for a later time.

In one embodiment, the equipment used by the driver of the autonomous vehicle to receive the call may be a smartphone, a navigation system, a video conferencing device integrated into the vehicle such as in the dashboard area, a laptop or tablet that the user may mount at some location in the autonomous vehicle, or any other type of display device that is either a standalone device or is a device that can be partially or fully integrated into the autonomous vehicle and have the capability to make and receive video conference calls. All such devices on which the video conference call can be made, received, and conducted are referred to herein as a driver's conferencing device. Such conferencing devices used by the driver may include a conferencing UI that can be configured by the control circuitry to implement different adaptations. Such conferencing devices may be detected by the system when they are present within the autonomous vehicle, such as via a hard-wired connection or a Bluetooth connection. Making such a detection may allow the system to distinguish between a device that is not in the autonomous vehicle and a device that is within the autonomous vehicle. Data relating to the device being within the autonomous vehicle may be shared with other participants of the video conference call, as further described in relation to FIG. 11.

When a request to join a video conference call is received, in one embodiment, at block 515, the mode of operation of the autonomous vehicle may be determined. The mode of operation may relate to a current mode in which the autonomous vehicle is being driven. These modes may be autonomous and non-autonomous modes. An autonomous mode may be associated with a state of driving in which the vehicle is driven automatically or in a self-driving state. It may also be associated with a driving mode in which the driver may safely engage in the video conference call, such as by looking at the UI that displays the video conference call, for example, if the autonomous vehicle is being driven in a rural area, at a low speed, in an area with fewer turns in the road, lesser traffic density, etc., as described above in block 102 of FIG. 1. A non-autonomous mode may be associated with the autonomous vehicle being driven manually. It may also include a driving condition that requires a higher level of attention from the driver.

At block 520, a determination may be made whether the autonomous vehicle is in autonomous mode. The control circuitry 220 and/or 228 may access autonomous vehicle data, such as an onboard computer, to determine whether the autonomous vehicle is being driven in autonomous or non-autonomous mode. The control circuitry 220 and/or 228 may also access the autonomous vehicle's surrounding to determine whether the current surroundings and driving mode may be associated with an autonomous mode. As described earlier, such surrounding data may include traffic density, which may be obtained by the control circuitry 220 and/or 228 by accessing the autonomous vehicle's sensors or cameras to view the surroundings.

If a determination is made at block 520 that the autonomous vehicle is not in an autonomous mode, then any one of the following next steps as depicted at block 530 may be executed by the control circuitry 220 and/or 228. In one embodiment, since the autonomous vehicle is not in an autonomous mode, the control circuitry 220 and/or 228 may not join the driver's conferencing device into the ongoing video conference call. In another embodiment, if the autonomous vehicle is not in an autonomous mode, the control circuitry 220 and/or 228 may join the driver's conferencing device into the ongoing video conference call but only in an audio-only mode. In other words, the control circuitry 220 and/or 228 may disable the live video from the video conferencing call, replace live videos of each participant with still images or icons, as described in block 104 of FIG. 1, and configure the UI of the driver's conferencing device such that the conference call may proceed as an audio-only conference call. In yet another embodiment, if the autonomous vehicle is not in an autonomous mode, the control circuitry 220 and/or 228 may alert the caller (i.e., the participant who is requesting to have the driver join the call) and inform the caller of the driver's vehicle's non-autonomous status (or mode). The control circuitry 220 and/or 228 may also provide notification options to the caller, which include alerting the caller when a switch has been made from the non-autonomous to autonomous mode.

Referring back to block 520, if a determination is made that the autonomous vehicle is in an autonomous mode, then, at block 535, the control circuitry 220 and/or 228 may join the driver's video conferencing device into the video conference call and at block 540 adapt the UI in the driver conferencing device and/or the other participants' UI with features associated with an autonomous mode of operation as described further in relation to FIGS. 9 and 10.

In another embodiment, at block 520 a determination may be made that the autonomous vehicle is driving in a non-autonomous mode. In response to determining that the autonomous vehicle is driving in a non-autonomous mode, the system may then determine road conditions, traffic density, and other driving situations to determine whether the autonomous vehicle can be driven in an autonomous mode. For example, although the road conditions, traffic density, and other driving situations may allow the autonomous vehicle to be driven in an autonomous mode, the driver may have chosen not to do so. When a determination is made that although the road conditions allow it, the driver simply chose to drive in a non-autonomous mode, then the system may automatically switch from no-autonomous to autonomous mode, or do so upon driver approval, when the drive is to join a video conference call.

FIG. 6 is a flowchart of a process 600 of tracking changes in mode of operation of an autonomous vehicle and adapting conferencing UI based on the tracked changes, in accordance with some embodiments of the disclosure. The process 600 may be implemented, in whole or in part, by systems or devices such as those shown in FIGS. 2 and 3. One or more actions of the process 600 may be incorporated into or combined with one or more actions of any other process or embodiments described herein. The process 600 may be saved to a memory or storage (e.g., any one of those depicted in FIGS. 2 and 3) as one or more instructions or routines that may be executed by a corresponding device or system to implement the method 600.

At block 610, the control circuitry 220 and/or 228 may determine the current mode of operation of the autonomous vehicle. The control circuitry 220 and/or 228, in some embodiments, may access published information to determine the current mode of operation of the autonomous vehicle. Such information may be published by the autonomous vehicle, the driver conferencing device, or a server associated with the autonomous vehicle or driver conferencing device.

In some embodiments, the mode of operation may be autonomous, and in other embodiments, the mode of operation may be non-autonomous. Whichever the current mode of operation may be, once it is determined, at block 620 the control circuitry 220 and/or 228 may track the current mode of operation. The control circuitry 220 and/or 228 may access the published information to continue to track current mode of operation.

At block 630, the control circuitry 220 and/or 228 may determine whether there is a switch in mode of operation. For example, if the current mode of operation was autonomous, then the control circuitry may determine whether the mode of operation switched from autonomous to non-autonomous and vice versa.

If a determination is made that a switch in mode of operation has occurred, then, at block 640, the control circuitry 220 and/or 228 may configure an adaptation for the UI associated with the driver's conferencing device and/or the participant's (non-driver's) conferencing device. Some examples of such adaptations associated with the mode of operation are described in relation to FIGS. 9 and 10.

If a determination is made that a switch in mode of operation has not occurred, then, at block 650, the control circuitry 220 and/or 228 may continue to display the current adaptation on the UI associated with the driver's conferencing device and/or the participant's (non-driver's) conferencing device.

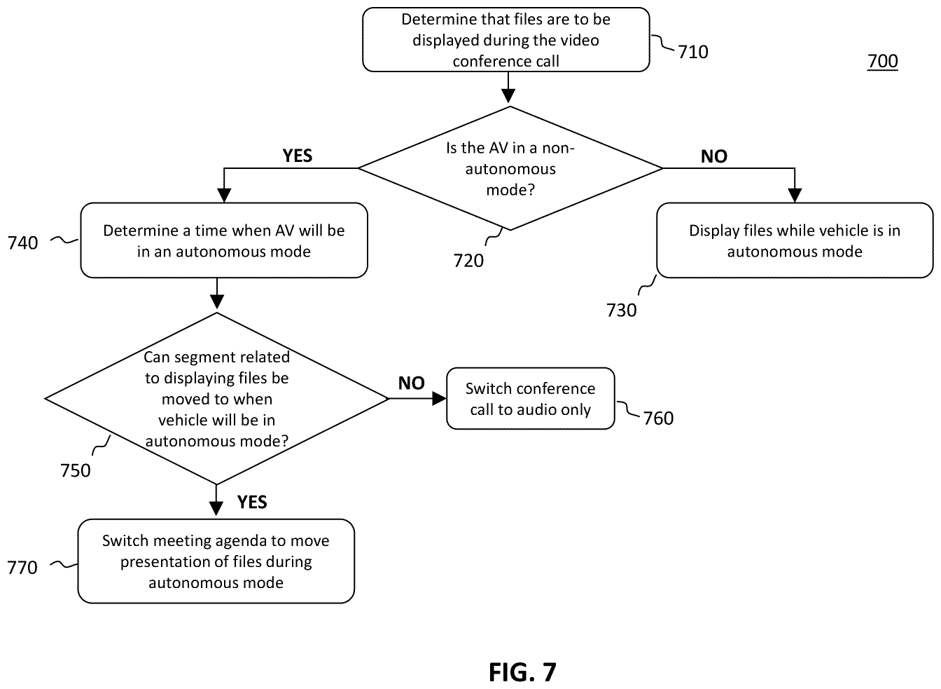

FIG. 7 is a flowchart of a process 700 for adapting the user interface of a conferencing device associated with an autonomous vehicle based on the type of files that are to be presented during a video conference call, in accordance with some embodiments of the disclosure. The process 700 may be implemented, in whole or in part, by systems or devices such as those shown in FIGS. 2 and 3. One or more actions of the process 700 may be incorporated into or combined with one or more actions of any other process or embodiments described herein. The process 700 may be saved to a memory or storage (e.g., any one of those depicted in FIGS. 2 and 3) as one or more instructions or routines that may be executed by a corresponding device or system to implement the method 700.

At block 710, in some embodiments, the control circuitry 220 and/or 228 may determine that files are to be displayed during the video conference call in which the driver of the autonomous vehicle will be a participant. To make that determination, the control circuitry 220 and/or 228 may access the meeting agenda of the video conference call, including any communications associated with the video conference call, such as emails, attachments to the meeting invite, and texts between participants. The control circuitry 220 and/or 228 may analyze all such data to determine whether any files will be displayed during the video conference call. For example, the control circuitry 220 and/or 228 may access an email from an email server in a company and determine whether the email is associated with the meeting and whether the email has any attachments that are to be displayed at the meeting. The control circuitry 220 and/or 228 may, in another example, access texts or emails, which may not have an attachment but may indicate that an employee, e.g., Michael, will show a PowerPoint during the meeting. The files that are to be displayed may include slides, such as PowerPoint or Google slides; documents, such as Microsoft Word, Excel, or Visio; or any other type of documents. The files to be displayed may also include a video, animation, and still images.

If files are to be displayed during the video conference call, the driver of the autonomous vehicle may need to pay attention by looking at the video conference call during the time the files are displayed. As such, it would be safer for the driver if the mode of operation of the autonomous vehicle is in an autonomous mode when the files are displayed such that the drive can gaze at the driver's conferencing device and not have to focus on driving.

At block 720, the control circuitry 220 and/or 228 may determine whether the current mode of operation autonomous vehicle (AV) is in a non-autonomous mode. The control circuitry 220 and/or 228, in some embodiments, may access published information to determine the current mode of operation of the autonomous vehicle. Such information may be published or broadcasted by the autonomous vehicle, the driver conferencing device, or a server associated with the autonomous vehicle or driver conferencing device.

In some embodiments, the control circuitry may determine the time during the meeting in which the files are scheduled to be presented, such as 10:40 AM. The timing of the presentation of the files may be determined by the control circuitry by accessing the agenda of the video conference call. The control circuitry may also determine whether at that time of the presentation of the files, i.e., 10:40 AM, whether the autonomous vehicle will be in autonomous mode.

If a determination is made at block 720 that the current mode of operation of the autonomous vehicle is in a non-autonomous mode, or the mode of operation at the time when the files are scheduled to be presented will be a non-autonomous mode, then the process may move to block 740, where the control circuitry 220 and/or 228 may determine a time in the future when the autonomous vehicle will be in an autonomous mode. To do so, the control circuitry 220 and/or 228 may access data associated with the autonomous vehicle, such as its routing map from the navigation system, and determine a next segment in which the autonomous vehicle can be driven in an autonomous mode. For example, referring to FIG. 12, if the autonomous vehicle is currently on segment 1, then the control circuitry may determine a time at which the autonomous vehicle will reach the start of segment 4 where the autonomous vehicle can be in a fully autonomous mode.

At block 750, the control circuitry 220 and/or 228 may determine if the segment related to displaying files can be moved to when vehicle will be in autonomous mode. The control circuitry 220 and/or 228 may display notifications to the presenter, or all participants, to determine if the segment related to displaying files can be moved. The control circuitry 220 and/or 228 may also indicate that the reason for the move is to accommodate the driver of the autonomous vehicle, and the control circuitry 220 and/or 228 may suggest a time to when the segment might be moved. The presenter or the participants may be provided an option to approve or disapprove a move in the meeting agenda. For example, if the presenter or the participant determine that the files are not relevant to the driver of the autonomous vehicle, they may disapprove the change in meeting agenda.

If the segment related to displaying files can be moved to when vehicle will be in autonomous mode, then, at block 770, the control circuitry 220 and/or 228 may automatically switch the meeting agenda of the video conference call such that the presentation of files is moved to a time when the autonomous vehicle will be in an autonomous mode.

If the segment related to displaying files cannot be moved to when vehicle will be in autonomous mode, then, at block 760, the control circuitry 220 and/or 228 may switch the video conference call to an audio-only mode for the driver. In other words, the control circuitry 220 and/or 228 may configure an adaptation for the UI associated with the driver's conferencing device to be in an audio-only mode and disable all live videos while still running and recording the video conference in its live mode for later viewing.

Referring back to block 720, if a determination is made at block 720 that the vehicle is currently not in a non-autonomous mode or will be in an autonomous mode at the time when the files are to be presented, then, at block 730, the control circuitry may display the files while the vehicle is in the autonomous mode.

FIG. 8 is a flowchart of a process 800 depicting changes from still images to live video and vice versa based on the current mode of operation of the autonomous vehicle, in accordance with some embodiments of the disclosure. The process 800 may be implemented, in whole or in part, by systems or devices such as those shown in FIGS. 2 and 3. One or more actions of the process 800 may be incorporated into or combined with one or more actions of any other process or embodiments described herein. The process 800 may be saved to a memory or storage (e.g., any one of those depicted in FIGS. 2 and 3) as one or more instructions or routines that may be executed by a corresponding device or system to implement the method 800.

At block 810, in some embodiments, the control circuitry 220 and/or 228 may display a live video conference call on the user interface of a conferencing device associated with a driver of an autonomous vehicle. In some embodiments, the live video conference call may be displayed when the mode of operation of the autonomous vehicle is in an autonomous mode. In other words, the driver of the autonomous vehicle may be able to gaze at the live video of the participants without having to pay much attention at the road since the autonomous vehicle may be currently driving in an autonomous mode.

At block 820, the control circuitry 220 and/or 228 may detect that the driver is currently looking at the road. In some embodiments, the control circuitry 220 and/or 228 make continuously track the gaze of the driver to determine whether the driver is gazing at the user interface associated with the conferencing device or at the road ahead.

When the determination is made that the driver is gazing at the road ahead, the control circuitry 220 and/or 228 may determine that the driver needs to focus on the road and not be distracted with the live image of all the participants. In some embodiments, the driver switching their gaze from the user interface to the road may be associated with a switch in current mode of operation from autonomous mode to a non-autonomous mode.

Accordingly, at block 830, the control circuitry 220 and/or 228 may switch from a live video to still images being displayed on the user interface of the conferencing device associated with the driver. One example of this still image, as displayed, may be to display cartoon still images instead of live videos of the other participants. The control circuitry 220 and/or 228 may also use an avatar, an icon, or a picture of each participant as a still image.

At block 840, the control circuitry 220 and/or 228 may invoke an emotion detector to detect changes in emotions of participants. Although the live videos may not be visible to the driver when the mode of operation is in a non-autonomous mode and still images are displayed on the UI, the live video content may still be streamed to the autonomous vehicle and processed in the background. One of the background processes may be an emotion detector 840. The emotion detector may determine a user's emotion by analyzing the captured video.

If there is something special during the video conference, for example, such as at block 850, when one participant has an exaggerated emotion or a raised voice, such as due to the participant not agreeing with someone, being angry, etc., then the control circuitry may switch from still images at block 830 back to live video at blocks 860 and 870. Such a switch may allow the driver to once again gaze at the live video of the video conference call. The control circuitry may detect such changes in emotions and exaggerated emotions by monitoring and detecting facial expressions of participants together with certain movements or gestures, for example, nodding, waving hands, scratching head, rubbing eyes, etc. In some embodiments, even if there is something special during the video conference, as described above at block 850, however, the driving conditions make it unsafe for the driver to gaze at the UI of the driver conferencing device, the switch from still images to live video will not occur. In other embodiment, the control circuitry, instead of automatically switching from still images to live video, may alert the driver audibly to whatever something special that occurred or may alert the driver that a change to a live video is warranted and seek the driver's approval to make the change from still images to live video.

In another embodiment, the system may detect a participant's change in emotion. When a change in emotion is detected, the system may determine whether the change in emotion is above a threshold. The threshold, for example, may be set at the participant's speaking volume getting louder or speaking at a faster pace, which may be associated with the participant getting angry, frustrated, or displeased with something happening in the video conference call. If the change is above a threshold, then in order to attract the driver's attention, the system may display an exaggerated version of the avatar on the UI of the driver's video conferencing device. For example, the exaggerated avatar may be displayed as a pop-up. Doing so will make the avatar more noticeable in the driver's peripheral vision. If the driver then looks at the exaggerated icon, the camera may detect the driver's gaze and then switch from the exaggerated icon to live video.

FIG. 9 is a block diagram of various adaptations that may be configured for the user interface associated with the conferencing device used by the driver of an autonomous vehicle, in accordance with some embodiments of the disclosure.

In some embodiments, a current mode of operation is determined by the control circuitry 220 and/or 228 for the autonomous vehicle. The mode of operation may be autonomous, non-autonomous, or other modes as depicted in block 102 of FIG. 1. If the mode of operation is determined to be autonomous, then the control circuitry 220 and/or 228 may configure any one or more of the adaptations in block 910. These adaptations may include, in one embodiment, as depicted at block 915, displaying live videos of other participants in the user interface of the conferencing device associated with the driver. The live video may be in the form of displaying a plurality of windows where each window displays a live video of the participant that is depicted in that window.

These adaptations may include, in one embodiment, as depicted at block 920, displaying a live video of the driver, such as in a window within the user interface of the conferencing device associated with the driver. The live video of the driver may also allow the driver to see what is being projected to other participants of the video conference call.

The adaptations may also include, in one embodiment, as depicted at block 925, displaying a duration of the autonomous mode. For example, the control circuitry may determine the amount of time the autonomous vehicle may continue to stay in an autonomous mode. If the autonomous vehicle is using a certain route and the current segment of the route allows the autonomous vehicle to operate in an autonomous mode, the driver may want to know how long the autonomous mode may continue so that the driver may plan next steps relating to the video conference call. For example, the control circuitry may determine that the duration that the autonomous vehicle may continue in the autonomous mode is 15 minutes. Based on duration, the driver or other participants receiving such information may decide to move up certain segments of the meeting in which certain files are to be displayed. Moving up or changing order of the presentation of segments may allow the driver or other participants to more effectively utilize the autonomous time remaining to present critical information in which the driver's participation is necessary or present files that the drive may gaze at.

The adaptations may also include, in one embodiment, as depicted at block 930, displaying an option to bookmark a point in the video conference call. The bookmark option may be selected via a voice command or via a touchscreen operation by the driver of the autonomous vehicle.

In some embodiments, the current mode of operation determined by the control circuitry 220 and/or 228 may be non-autonomous. When a non-autonomous mode of operation is determined, the control circuitry 220 and/or 228 may configure any one or more of the adaptations in block 940. These adaptations may include, in one embodiment, as depicted at block 945, displaying still images of other participants. These may be any images, icons, avatars, or images of the participant themselves. The still images may be displayed in the UI of the driver's conferencing device such that when the autonomous vehicle is in a non-autonomous mode, the driver may focus on the road rather than having to look at a live video showing the participants in the video conference call.

In some embodiments, the adaptations configured for the UI of the driver's conferencing device when the autonomous vehicle is in a non-autonomous mode may include, as depicted at block 950, a display duration of the non-autonomous mode. In this embodiment, the control circuitry may determine the amount of time the autonomous vehicle may continue to stay in the non-autonomous mode. If the autonomous vehicle is using a certain route and the current segment of the route permits the autonomous vehicle to operate in a non-autonomous mode and then an upcoming segment may allow the vehicle to operate in an autonomous mode, such information may be displayed on the UI of the driver's conferencing device. Having such knowledge may equip the driver, and other participants, to plan the meeting accordingly, such as wait until the autonomous vehicle operates in an autonomous mode to present information critical to the driver or present certain segments of the meeting in which certain files are to be displayed.

In some embodiments, the adaptations configured for the UI of the driver's conferencing device when the autonomous vehicle is in a non-autonomous mode may include, as depicted at block 955, a display of route changes or alternative routes. In this embodiment, the control circuitry 220 and/or 228 may determine an importance level associated with the meeting or a segment of the meeting, The importance levels may range from 1-10, low to high, or some other scale. It may also deem a meeting important based on who is attending the meeting or who is presenting in the meeting, including if the driver is to present a portion of the meeting. The importance of the video conferencing call may also be determined based on the content and context of the call. Depending on the importance of the video conference call, i.e., if it exceeds a threshold level of importance, then the control circuitry 220 and/or 228 may display the route changes or alternatives routes such that the autonomous vehicle may be driven in an autonomous segment during the video conference call or at least during an important segment of the video conference call.

In some embodiments, the adaptations configured for the UI of the driver's conferencing device when the autonomous vehicle is in a non-autonomous mode may include, as depicted at block 960, a display of a request to change the meeting agenda of the video conference call. In this embodiment, the control circuitry 220 and/or 228 may determine that a segment of the video conference call is important and requires attention from the driver of the autonomous vehicle. As such, if a determination is made that, based on the current agenda of the video conference call, the important segment of the video conference call will be presented when the autonomous vehicle is a non-autonomous mode, then the control circuitry 220 and/or 228 may display the request to change or shuffle the agenda such that the important segment can be presented when the autonomous vehicle is in the autonomous mode, thereby allowing the driver to gaze at the UI when the segment is presented.

In some embodiments, the adaptations configured for the UI of the driver's conferencing device when the autonomous vehicle is in a non-autonomous mode may include, as depicted at block 965, displaying an option to bookmark a point in the video conference call. The bookmark option may be selected via a voice command or via a touchscreen operation by the driver of the autonomous vehicle.

In some embodiments, the adaptations configured for the UI of the driver's conferencing device when the autonomous vehicle is in a non-autonomous mode may include, as depicted at block 970, displaying an option to use an audio-only option. In this option, the video conference call may be conducted in an audio-only format where the video is switched off and the still images also are switched on, or where both the video and the still images are switched off. Other adaptations 935 and 975 may include customized adaptations that the driver of the autonomous vehicle, or a participant, may configure. The driver of the autonomous vehicle, or a participant, may also set a trigger when such an adaptation is to be activated.

In some embodiments, even though a determination may be made that the autonomous vehicle is being driven in a non-autonomous mode, which may lead to dynamically configuring the driver's user interface with adaptations described at block 940, in some scenarios, autonomous adaptation may be configured instead. One such scenario may be when the video conference call is a one-directional webinar in which the driver simply has to listen in and does not respond back to the speaker. In such a scenario, since the engagement is only listening and seeing the video of the webinar, even if the automobile is in non-autonomous mode, autonomous adaptations of block 910 may be configured. As such, the system may determine the type of conference call (e.g., webinar, one-directional call-in which driver does not respond back and is a receive only call, or a video conference call that requires driver's engagement) to determine whether autonomous adaptations of block 910 may be configured despite the automobile being driven in a non-autonomous mode.

FIG. 10 is a block diagram of various adaptations that may be configured for the user interface associated with the conferencing device used by the participant (non-driver) of the video conference call, in accordance with some embodiments of the disclosure.

In some embodiments, a current mode of operation is determined by the control circuitry 220 and/or 228 for the autonomous vehicle. The mode of operation may be autonomous, non-autonomous, or other modes as depicted in block 102 of FIG. 1. If the mode of operation is determined to be autonomous, then the control circuitry 220 and/or 228 may configure any one or more of the adaptations in block 1010 for the UI of the conferencing device associated with the non-driver participant. The non-driver participant may be any participant of the video conferencing call that will not be driving an autonomous vehicle during the video conferencing call, or the non-driver participant may be the caller or initiator of the video conferencing call.

The adaptations described in FIG. 10 are to be configured by the control circuitry 220 and/or 228 for other participants of the video conference call and not the driver of the autonomous vehicle. The adaptations for the driver of the autonomous vehicle are discussed in FIG. 9. The adaptations described in FIG. 10 may be in lieu of or in addition to the adaptations described in FIG. 9.

In some embodiments, a determination may be made that the autonomous vehicle is currently operating in an autonomous mode. Since the driver of the autonomous vehicle may be able to focus on the video conferencing call while the autonomous vehicle is in an autonomous mode, the control circuitry 220 and/or 228 may provide additional or different features to the non-driver participant that they may use in communicating with the driver of the autonomous vehicle. One such adaptation, as depicted at block 1015, is displaying a live video of the driver. Since the driver may be able to gaze at the UI of their conferencing device during the video conferencing call, a camera associated with the driver's video conferencing device may capture a live image of the driver and display it on the UI of other participants. In another embodiment, when bandwidth to do so is available, instead of a live image of the driver, a live video of the driver may be displayed to other participants.

The adaptations may also include, in one embodiment, as depicted at block 1020, displaying at duration of the autonomous mode on the UI of non-driver participants. For example, the control circuitry may determine the amount of time the autonomous vehicle may continue to stay in an autonomous mode. If the autonomous vehicle is using a certain route and the current segment of the route allows the autonomous vehicle to operate in an autonomous mode, the non-driver participants may want to know how long the autonomous mode may continue so that they can plan next steps relating to the video conference call. For example, the non-driver participants may shift the agenda of the meeting such that information that is relevant to the driver may be conveyed while the driver is still able to gaze at the video conference call, i.e., while the autonomous vehicle is still in the autonomous mode. Accordingly, the control circuitry 220 and/or 228 may configure the UI of non-driver participants by displaying a timer, a stopwatch, or some other indicator that informs the non-driver participants of the duration of the autonomous mode.

In some embodiments, the current mode of operation determined by the control circuitry 220 and/or 228 may be non-autonomous. When a non-autonomous mode of operation is determined, the control circuitry 220 and/or 228 may configure any one or more of the adaptations in block 1030 for the non-driver participants. These adaptations may include, in one embodiment, as depicted at block 1035, an option to conduct the video conference without a live video for the driver and in an audio-only format. This may include switching from a live video to still images being displayed for just the driver or for all the participants of the video conference call.

In some embodiments, another adaptation that may be configured on the UI of the non-driver participant when the autonomous vehicle is in non-autonomous mode includes, as depicted at block 1040, includes scheduling a conference time. The control circuitry 220 and/or 228 may allow the non-driver participant to schedule a time with the driver or based on the autonomous mode of the autonomous vehicle. For example, based on the published data the non-driver participant may see when the autonomous vehicle will be in an autonomous mode, such as at 10:17 AM. Accordingly, the non-driver participant may schedule the call to start at 10:17 AM.

In some embodiments, one adaptation that may be configured by the control circuitry 220 and/or 228 on the UI of the non-driver participant when the mode of operation of the autonomous vehicle is in non-autonomous mode includes, as depicted at block 1045, alerting the non-driver participant when the autonomous vehicle is in an autonomous mode. In this embodiment, the control circuitry 220 and/or 228 may determine a time in the future when the autonomous vehicle may be in an autonomous mode. The control circuitry 220 and/or 228 may make such a determination based on a route taken by the autonomous vehicle, such as the route displayed in FIG. 12. The control circuitry 220 and/or 228 may then transmit an alert to the non-driver participant when the autonomous vehicle, which may currently be in non-autonomous mode, changes to an autonomous mode. The control circuitry 220 and/or 228 may also transmit the alert at a predetermined time before the autonomous vehicle reaches the autonomous mode, such as five, 10, or 15 minutes before it reaches the autonomous mode.

In some embodiments, another adaptation that may be configured on the UI of the non-driver participant when the autonomous vehicle is in non-autonomous mode includes, as depicted at block 1050, includes selecting meeting importance level. The control circuitry 220 and/or 228 may allow the non-driver participant to select a meeting importance level at any time while the video conference call is in progress or at any time prior, such as in the scheduling stage of the video conference call. In some embodiments, the control circuitry 220 and/or 228, or a server associated with the video conference call, may automatically determine the importance level of the meeting, such as by using an AI engine, and assign the importance level to the meeting. For example, importance level may be automatically assigned based on the topics to be discussed, the type of participants that are attending the video conference call (e.g., upper management, CEO, etc.), and/or deadline associated with items to be discussed during the video conference call.

In some embodiments, another adaptation that may be configured on the UI of the non-driver participant when the autonomous vehicle is in non-autonomous mode includes, as depicted at block 1055, an option to shift the meeting agenda. This adaptation may allow participants, or the driver, to shift the meeting agenda such that portions of the meeting that are relevant to the driver are automatically shuffled such that they are presented during a time when the driver may be able to gaze at the video conference call, i.e., when the autonomous vehicle may be in an autonomous mode. In this adaptation, the control circuitry 220 and/or 228 may map one or more meeting items relevant to the driver with windows of time when the autonomous vehicle may be in autonomous mode. The control circuitry 220 and/or 228 may access the vehicle's route map to determine all such windows of time when the autonomous vehicle may be in autonomous mode and automatically shuffle the agenda. In some embodiments, the control circuitry 220 and/or 228 may display the reshuffled agenda as a suggestion and implement it only after approval from a key participant, all participants, or a majority of the participants.

Other adaptations 1060 (display still image for the driver) and 1065 (other) may include customized adaptations that the non-driver participant may configure. The non-driver participant may also set a trigger when such adaptation is to be activated. Some examples of such additional adaptations may include bookmarking options and meeting recording options. In some embodiments, the caller may not know when adding another user to the video conference call that the other user is currently driving the autonomous vehicle in a non-autonomous mode. As such, based on the determination that the driver is currently driving in a non-autonomous mode, the caller's UI may dynamically change to any one of the options described in FIG. 10, such as a audio call only or scheduling mode. As described further in FIG. 11, such determination that driver is currently driving in a non-autonomous mode may be determined based on the autonomous vehicle publishing such data to the caller. Accordingly, the UI for the caller may continue to dynamically change as the changes in the driver's autonomous status of the autonomous vehicle keeps changing, i.e., different UI for when the autonomous vehicle is in autonomous mode and different UI when the autonomous vehicle is in non-autonomous mode.

In some embodiments, the user interface associated with the driver and the caller may dynamically change and provide different sets of functionalities as the autonomous vehicle changes its autonomous state. If the autonomous vehicle is in an autonomous state, then a first set of functionalities may be displayed on the user interface associated with the driver and the caller and if the autonomous vehicle is in a non-autonomous state, then a second set of functionalities may be displayed on the user interface associated with the driver and the caller. In another embodiment, the first set of video conferencing functionality is provided on the user interface of the caller device when the autonomous state of the autonomous vehicle is in an autonomous state and when a change is detected in the autonomous status, such as from autonomous state to non-autonomous state, then the control circuitry automatically changes from the first set of video conferencing functionality to the second set of video conferencing functionality. Some examples of the first set of functionalities are described in relation to blocks 910 in FIGS. 9 and 1010 in FIG. 10 and some examples of the second set of functionalities are described in relation to blocks 940 in FIGS. 9 and 1030 in FIG. 10.

As described above in relation to block 940 of FIG. 9, likewise in relation to block 1030 of FIG. 10, in certain scenarios, even if the automobile is in non-autonomous mode, autonomous adaptations of block 1030 may be configured. These scenarios may be related to the type of the type of video conference call. In other words, is the video conference call a webinar or a type that is one-directional call-in which does not require the driver to respond back or is it of a type that requires more of the driver's attention. If the video conference call is a one-directional webinar type, where it is a receive only type of call, then, since it requires lesser driver attention and engagement, autonomous adaptations of block 1010 may be configured.

FIG. 11 is a block diagram of categories of data that may be published by the autonomous vehicle, in accordance with some embodiments of the disclosure. Any one or more of the autonomous vehicles, the driver conferencing device, or a server associated with the autonomous vehicle or driver conferencing device may publish the current mode of operation of the autonomous vehicle. Such information may be used to determine which adaptations to configure for the UI of non-driver participant devices.

In some embodiments, the information published may relate to the current autonomous mode 1105. The control circuitry 220 and/or 228 may access the autonomous vehicle's camera, sensors, onboard computer, a live image of the driver and the surroundings to determine the current autonomous mode 1105 of the autonomous vehicle. For example, the control circuitry may access the onboard computer and determined that the onboard computer of the autonomous vehicle is automatically driving the autonomous vehicle and it is not being manually controlled. In another example, a camera that is associated with the driver's conferencing device or integrated into the autonomous vehicle may monitor the driver. Based on the monitoring, a determination may be made that driver is focusing on the road or focusing on something else other than the road. If a determination is made based on the camera input that the driver is currently focusing on the road, then the control circuitry may determine that the driver is engaged in driving and the autonomous vehicle is being operated in an non-autonomous mode. On the flip side, if a determination is made based on the camera input that the driver is currently doing personal tasks and not looking at the road, then the control circuitry may determine that the driver is not engaged in driving and the autonomous vehicle is currently operating in an autonomous mode. In some instances, even if the data from the onboard computer suggests that the automobile is being currently driven in autonomous mode, if the live camera input shows that the driver is paying attention to the road, the live camera input may supersede the onboard computer input since the driver is focusing on the road despite the car being in autonomous mode. In such a situation, the control circuitry 220 and/or 228 may make a determination that the vehicle is operating in a non-autonomous mode.

In another embodiment, published information may include, as depicted at 1110, the duration of the autonomous mode. It may also publish duration of one or more upcoming autonomous (modes) statuses 1115. The control circuitry 220 and/or 228 may determine such durations and upcoming statuses based on accessing the route map of the autonomous vehicle, which may also be published as depicted at 1120.

In another embodiment, published information may include, as depicted at 1125, alternative routes to reach the final destination. In some embodiments, an importance level may be associated with the video conferencing call. The importance level may be assigned by a participant or may be automatically assigned. Depending on the importance of the video conference call, i.e., if it exceeds a threshold level of importance, then the control circuitry 220 and/or 228 may publish alternative routes 1125, vehicle parking date 1130, or time to destination 1135 such that the information may be used by the driver or other participants to either reschedule the call or shift agenda items to align with the vehicle's autonomous mode. For example, if the importance level exceeds an importance threshold, the published data may be used by the driver to adopt an alternative route such that the driver may gaze at the video conference call, at least for those segments that are relevant to the driver. In another embodiment, a participant may obtain the information published that relates to time to destination 1135 and reschedule the call or shuffle an agenda item to be discussed on the call that is relevant to the driver once the driver has reached the final destination where the driver may be able to focus on the video conference call.

Other information published may include camera/sensor data 1140, such as images or live videos of landscape surrounding the autonomous vehicle. Such data may be used to determine the safety of the driver, such as a higher level of safety when the autonomous vehicle is in a rural area with sparse traffic.

In another embodiment, published information may include, as depicted at 1145, the driver's preference for conference calls for each autonomous mode. In this embodiment, the driver may have set their own preferences as to what features are to be allowed when the driver's autonomous vehicle is in an autonomous or non-autonomous mode. For example, even if the vehicle is in an autonomous mode, the driver may have set a preference not to display a live video of the driver and only to show live video of other participants. The driver may, for example, not want to have their video turned on because they are not properly dressed or do not want to disclose their background scenery to other participants. Whatever the preference may be, the control circuitry may publish such driver preferences such that the conferencing device, server, or conferencing devices of other participants may provide feature capabilities that align with the driver's preferences.

In another embodiment, published information may include, as depicted at 1150, types of notifications/data sharing authorized. In this embodiment, the driver may or may not want to share certain details, such as their location, with certain participants. As such, such sharing and notification preferences may also be published by the control circuitry.

FIG. 12 is an example of a route that may be taken by the autonomous vehicle and various autonomous and non-autonomous segments along that route, in accordance with some embodiments of the disclosure. In some embodiments, the autonomous vehicle may be traveling from Point A to Point B. Along its route, the autonomous vehicle may encounter different segments, some of which may allow the autonomous vehicle to be driven in autonomous mode and some that may not allow it to be driven in autonomous mode.

As depicted in this embodiment, the autonomous vehicle may be driven through segments 1 and 5 of the route in a non-autonomous mode and through segment 4 in an autonomous mode. The control circuitry 220 and/or 228 may determine which portions will be autonomous and non-autonomous based on data gathered from various sources, such as from a navigation map used by the autonomous vehicle to get from Point A to B.

Based on the mode of operation for each segment, the control circuitry 220 and/or 228 may implement an adaptation for the UI of the driver's conferencing device that aligns with the mode of operation. For example, the control circuitry 220 and/or 228 may configure UI adaptations depicted in block 910 of FIG. 9 when the autonomous vehicle is being driven in autonomous mode and may configure UI adaptations depicted in block 940 when the autonomous vehicle is being driven in a non-autonomous mode.

In some embodiments, the control circuitry 220 and/or 228 may anticipate a mode of operation for the autonomous vehicle by accessing a plurality of sources associated with the driver, such as the driver's calendar, to determine the driver's calendared appointments, events, and locations. Based on the calendared appointments, or other data obtained, the control circuitry may determine the route that the driver may take to get to the destination, timing of the drive, and the various types of autonomous and non-autonomous segments that will be encountered along the path. The control circuitry may then publish the data for use in planning for a video conference call.

Once a mode of operation is determined, or is anticipated, the control circuitry 220 and/or 228 may configure any one of more adaptations as described in FIGS. 9 and 10. For example, the control circuitry 220 and/or 228 may enable an audio-only option if the autonomous vehicle is currently going through segment 1. If the caller, i.e., the non-driver participant, is going to invite the driver to join a video conference call, the UI for the non-driver participant will alert the caller that this driver can join in audio-only mode. Accordingly, the control circuitry may enable or disable an option (e.g., Meet with Video) prior to initiating the call. To do so, the control circuitry may query to determine the current mode of operation and accordingly enable or disable the video calling option.

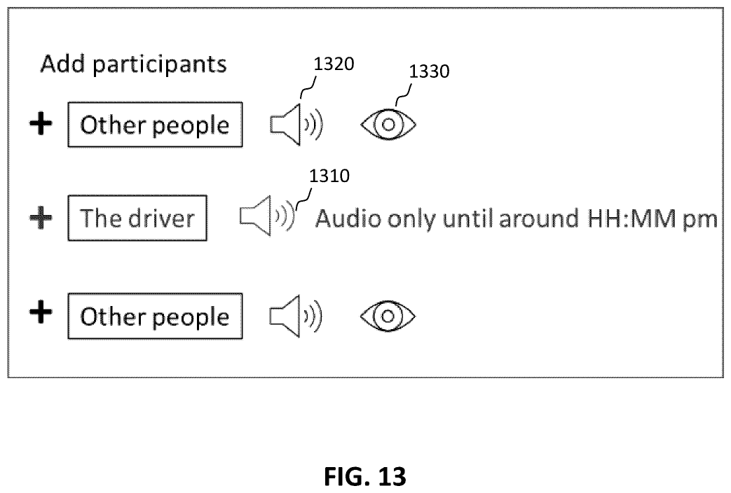

FIG. 13 is an example of a UI adaptation for the UI of a conference device of a non-driver participant for configuring audio or video settings for the video conference call, in accordance with some embodiments of the disclosure.

In this embodiment, the caller or non-driver participant may initiate an urgent video conference call. When the call is being initiated, the UI of the conferencing device associated with the non-driver participant (or caller) may indicate that the driver is currently driving the car in a non-autonomous mode. The control circuitry 220 and/or 228 may then determine, based on the route taken by the autonomous vehicle, that driver will be able to drive in autonomous mode after 15 minutes. As such, the control circuitry 220 and/or 228 may initiate the conference call in standby mode until the autonomous vehicle becomes fully autonomous. For example, the control circuitry 220 and/or 228 may implement a UI adaptation that has an auto-call feature that will automatically call the driver when the autonomous vehicle the driver is driving switches to autonomous mode. The control circuitry 220 and/or 228 may obtain permission from the driver prior to initiating the call. The control circuitry 220 and/or 228 may also implement other UI adaptations such as “Alert me when the vehicle parks.” This way the caller can decide whether they want to call the driver or not.

As described earlier, in some embodiments, the autonomous vehicle, the driver conferencing device, or a server associated with the autonomous vehicle or driver conferencing device may publish the current mode of operation of the autonomous vehicle. In other embodiments, an automobile location service, which may be a third party, may also publish location data and speed of the autonomous vehicle. The data may be published, and it may indicate whose video conference account it relates to. For example, the published data may indicate that it is associated with a Zoom™ account or username of a user, e.g., a driver of the autonomous vehicle. The published data may not be visible to the participant booking the meeting for privacy reasons; however, the data may be used to enabled various adaptations as discussed in relation to FIGS. 9 and 10. In some embodiments, when an autonomous vehicle is associated with multiple video conferencing accounts, such as multiple Zoom accounts relating to a husband and wife who use the same automobile, then the account that is logged in is used.

As depicted in FIG. 3, in this embodiment, an audio-only icon 1310 is shown next to the driver while both audio and video icons 1320 and 1330 are shown for other non-driver participants. This is because the driver is currently driving the autonomous vehicle in non-autonomous mode in segment 1 of the route from Point A to Point B in FIG. 12.

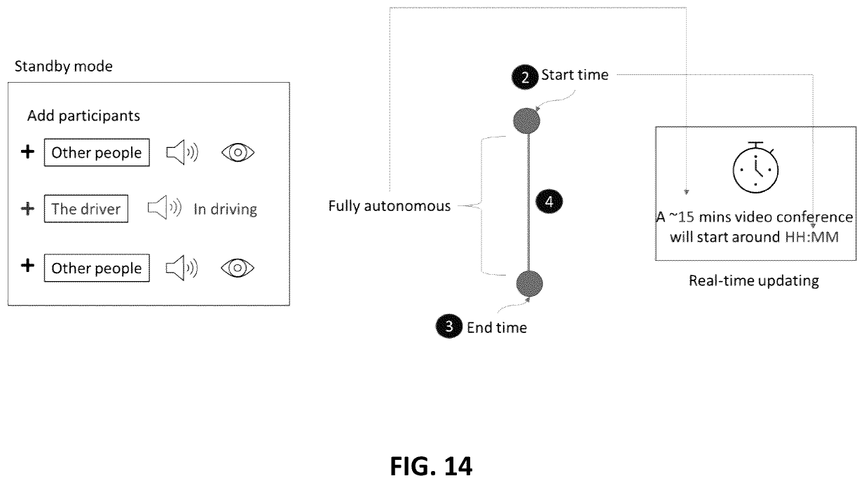

FIG. 14 is an example of implementing a standby mode, in accordance with some embodiments of the disclosure. In this embodiment, the control circuitry 220 and/or 228 may collect real-time data associated with the mode of operation of the autonomous vehicle. The mode of operation may be autonomous, non-autonomous, or another mode as depicted in block 102 of FIG. 1. If the mode of operation is determined to be non-autonomous, then the control circuitry 220 and/or 228 may implement a standby adaptation for the UI for conference devices associated with the caller or non-driver participants.

In the standby mode, in one embodiment, the control circuitry 220 and/or 228 may collect the autonomous vehicle's scheduled future autonomous time to determine a video conference time. Since traffic conditions may change at any time, which may cause delays to reach the segment when the autonomous vehicle will be in autonomous mode, the control circuitry 220 and/or 228 may revise the earlier estimate made of when the autonomous vehicle may be in an autonomous mode.

In the embodiment depicted in FIG. 14, the control circuitry 220 and/or 228 may estimate that the autonomous vehicle will reach a starting point of the autonomous segment 4 within 15 minutes. Accordingly, the control circuitry 220 and/or 228 may initiate the call in a standby mode and provide a timer or clock on the UI of the participant to show an estimated amount of time, which is 15 minutes in this example, for the autonomous vehicle to reach the autonomous mode. The timer may be automatically adjusted based on delays or sped up if the autonomous vehicle will reach the autonomous segment faster than anticipated. In some embodiments, the control circuitry 220 and/or 228 may provide updated alerts as the estimated time to autonomous mode changes.

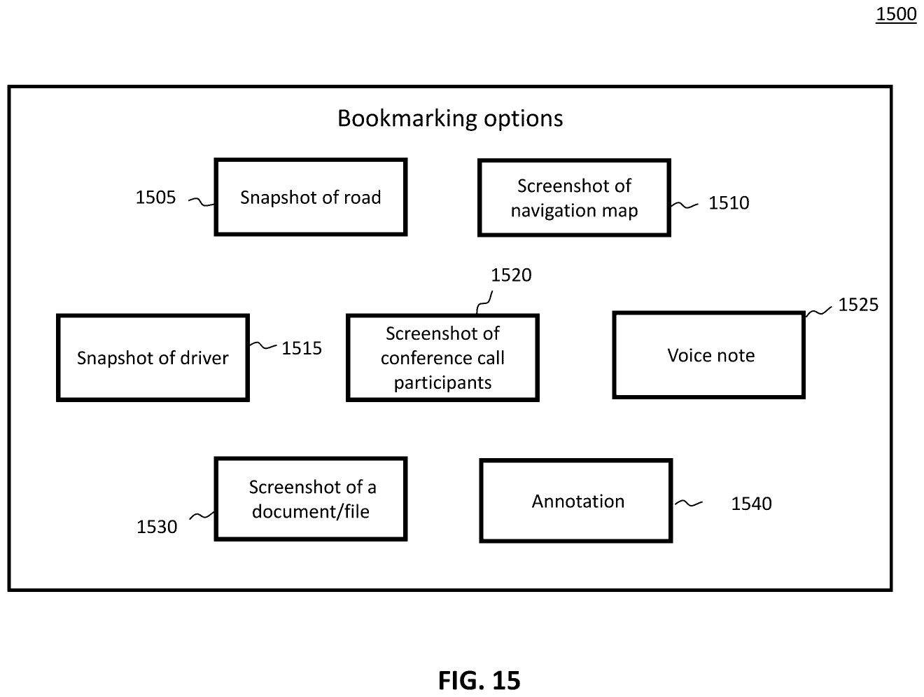

FIG. 15 is a block diagram of categories of bookmarking options for bookmarking segments of a video conference call, in accordance with some embodiments of the disclosure. In some embodiments, the driver of an autonomous vehicle may be engaged in a video conference call while the autonomous vehicle is in motion. There may be several modes of operation of the autonomous vehicle while the driver is engaged in the video conference call. These modes of operation may include an autonomous mode and a non-autonomous mode. The modes of operation may also include other modes as depicted in block 102 of FIG. 1, such as parked mode.

When the driver is engaged in the video conference call while in the autonomous vehicle, due to space restrictions and mode of operation, the driver may not be able to engage in the video conference call the same way the driver may engage when sitting at an office desk. For example, if the driver were to be engaged in the video conference call while at his office desk, the driver may have been able to take notes in a physical notebook, write something on a slide being displayed on their laptop, tag a portion of a presentation, or open a separate window and take down meeting minutes. However, since the driver is engaged in the video conference call while in the autonomous vehicle, many such tasks may not be possible.

In some embodiments, considering that driver may not perform meeting-related tasks such as taking notes, tagging a slide, preparing meeting minutes, etc., the control circuitry may configure the UI of the driver's conferencing device to allow the driver to bookmark portions of the video conference call. For example, if the driver of the autonomous vehicle is manually driving the autonomous vehicle, i.e., the autonomous vehicle is in a non-autonomous mode, then the control circuitry 220 and/or 228 may present bookmarking options 1500 via the conferencing UI in the driver conferencing device. The bookmarking options may allow the driver to bookmark a point in the video conference such that if the driver misses a portion in the video conference due to a distraction or due to having to manually drive the autonomous vehicle, the driver can, at a later time, go back to the missed portion based on the bookmark. In some embodiments, the control circuitry 220 and/or 228 may present bookmarking options 1500 via the conferencing UI in the driver conferencing device only when the autonomous vehicle is being driven in a non-autonomous mode. In other embodiments, the control circuitry 220 and/or 228 may present bookmarking options 1500 even when the autonomous vehicle is in an autonomous mode or in a parked mode. The control circuitry 220 and/or 228 may present the bookmarking options 1500 in some embodiments only to the driver and in other embodiments to all participants of the video conferencing call.

In some embodiments, the mode of operation may change from autonomous to non-autonomous. For example, in fully autonomous mode, the driver may be looking at a presentation slide on the UI in the driver conferencing device and, due to change in driving conditions, may have to switch to focusing on the road thereby switching from autonomous to non-autonomous mode. Assuming the video conference call is being recorded, then UI in the driver conferencing device may be configured to allow the drive to add a bookmark.

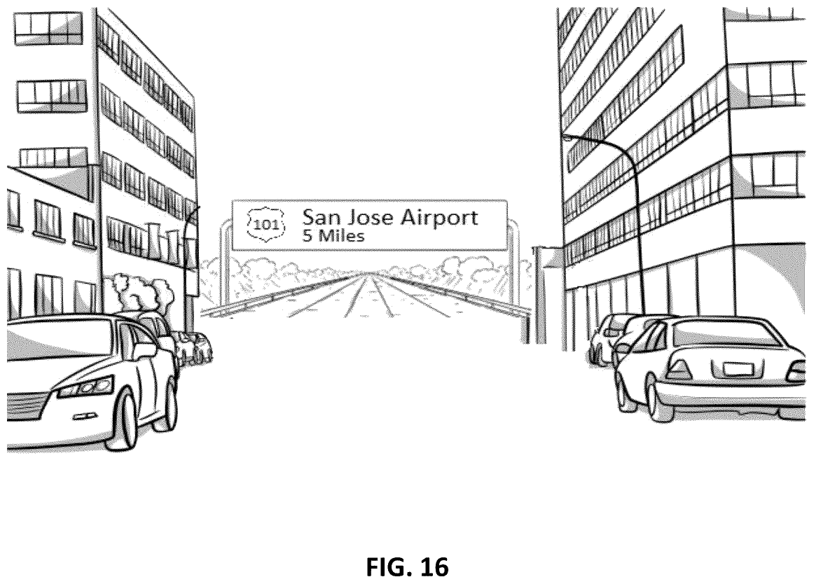

Whatever the reason may be to add a bookmark and whether the bookmarking option is presented when the autonomous vehicle is in an autonomous mode or a non-autonomous mode, in one embodiment, the bookmarking option may include taking a snapshot of the road 1505. One example of such a snapshot is depicted in FIG. 16. In this embodiment, the camera associated with the autonomous vehicle, or another camera, such as a camera of the conferencing device, a mobile phone, or another separate device, may take a snapshot of the road ahead. As depicted in FIG. 16, the snapshot taken shows that the autonomous vehicle at the time the snapshot is taken was approaching a highway sign that reads “San Jose Airport 5 Miles.”

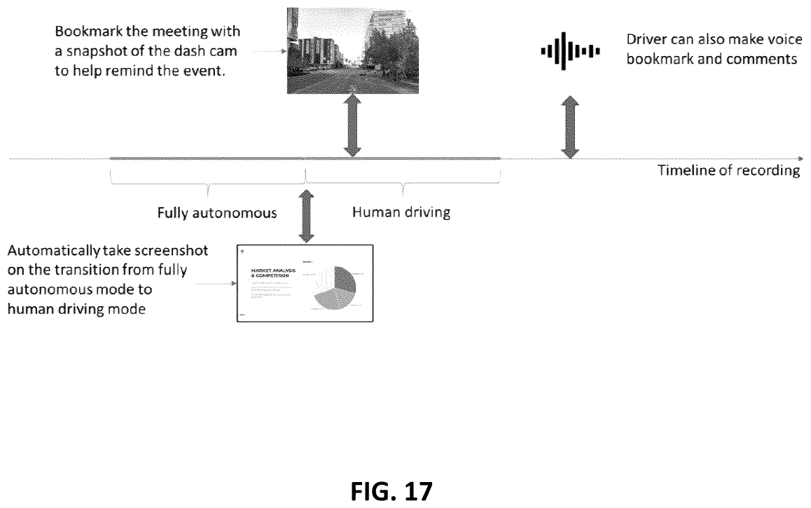

The snapshot in FIG. 16 may be saved as a bookmark to a recording of the video conference call. The bookmark may then be associated with a timestamp in the video conference call recording. To take the snapshot, the driver of the autonomous vehicle may utter a wake word or catch phrase, perform a hand gesture, or utter some other word that is recognized by the conferencing device, autonomous vehicle, or a server associated with the conferencing device or autonomous vehicle. Existing voice-enabled systems, such as Amazon's Alexa™ or Apple's Siri™, may also be used in coordination with UI of the driver's conferencing device to enable taking of the snapshot. One example of the snapshot of the road ahead displayed on a timeline of the video conference call's recording is depicted in FIG. 17.

In another embodiment, the bookmarking option may include taking a screenshot of the navigation map 1510. In this embodiment, the control circuitry 220 and/or 228 may access the navigation map displayed on the navigation screen of the autonomous vehicle. If the navigation map is displayed on another display, such as separate device that is located in the autonomous vehicle, such as a Garmin™ or some other GPS dash mount, or on the display of the conferencing device or a smartphone, the control circuitry 220 and/or 228 may access such a display and take a snapshot. The snapshot may depict a route map or a point in the route where the autonomous vehicle is currently located on its route. For example, the snapshot of the navigation may show that the autonomous vehicle is currently near the Lawrence exit or next to XYZ restaurant, etc.

In another embodiment, the bookmarking option may include taking a snapshot or screenshot of the driver 1515. Since a video camera associated with the autonomous vehicle, a separate device located in the autonomous vehicle, or a camera associated with the video conference device may be used to monitor the driver, a live snapshot or image of the driver may be taken and used as a bookmark. For example, at any particular moment during the video conferencing call, upon the occurrence of a trigger, such as a wake word, hand gesture, etc., the control circuitry 220 and/or 228 may access the camera and take a live snapshot or image of the driver. The live snapshot or image of the driver may show an emotion of the driver, an action or expression of the driver, or any gesture that the driver was performing while the snapshot is taken.

In another embodiment, the bookmarking option may include taking a snapshot or screenshot of the conference call participants 1520. Upon the occurrence of a trigger, such as a wake word, hand gesture, etc., the control circuitry 220 and/or 228 may capture a screenshot of the participants as displayed on the UI of the driver's video conferencing device.

In another embodiment, the bookmarking option may include a voice note 1525. Since a microphone associated with the autonomous vehicle, a separate device located in the autonomous vehicle, or the video conference device may be used by the driver during the video conferencing, upon the occurrence of a trigger, such as a wake word, hand gesture, etc., the control circuitry 220 and/or 228 may record a voice note by the driver and save it as a bookmark. The voice note may include any message that the driver wants to save as a bookmark for reminding them of their thoughts relating to what occurred in the video conference call at that moment. For example, the driver may save a voice note that may be an action item for themselves that relates to something that occurred in the video conference call.

In some embodiments, the bookmark may also be a screenshot of a document or presentation 1530 being presented on the video conference call. For example, if there is a presentation or document being displayed on the UI in the driver conferencing device, the control circuitry may associate the bookmark with a corresponding point in time in the video conference when a page of the document or a slide of the presentation was presented. The bookmark may then be stored with the recording of the video conference call and be retrieved to remind the driver where they have left off.

In some embodiments, the bookmark may also be an annotation 1540, such as comments, edits, and notes associated with a document presented during the video conference call. The annotation may be incorporated or associated with the document that was presented. For example, if the document is shared, then either the driver of the autonomous vehicle or a non-driver participant of the video conference call may insert an annotation to the document presented. For example, the driver of the autonomous vehicle may utter words that insert comments for a specific sentence, section, or page, of the document and such insertion may be used as a bookmark for later retrieving and reviewing the document.

In some embodiments, the video conferencing system may determine whether the document shared during the video conference call was shared from a local source (e.g., the presenter's Desktop) or shared from a shared resource, such as Box™ or another type of cloud sharing system. Regardless of the source of the document, the video conferencing system may automatically generate a local copy of the annotated document for the driver of the autonomous vehicle and save it to a local storage. The video conferencing system may also tag the saved document with the name of the meeting (e.g., name/date, etc.) and tag annotations with names of individuals that inserted the annotations.

Although some examples of bookmarking options were discussed, the embodiments are not so limited and other types of bookmarks that are customized may also be included. For example, a bookmark option may include a screenshot of the surroundings of the autonomous vehicle. Some examples of bookmarks, such as snapshot of the road, screenshot of a PowerPoint slide, and a voice note are displayed on a timeline of the video conference call's recording as depicted in FIG. 17.

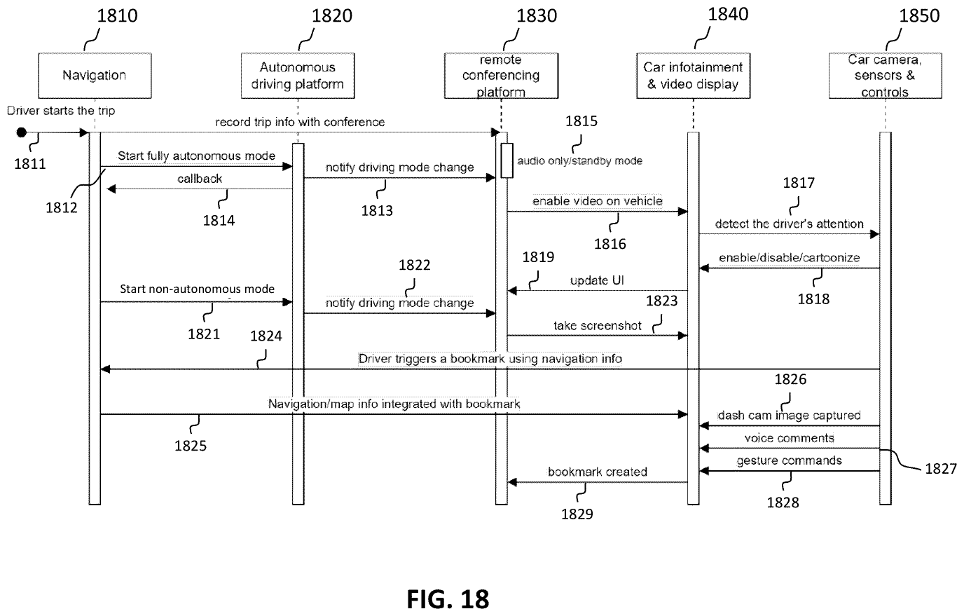

FIG. 18 is a flowchart of a process 1800 of communications between a plurality of devices for determining a mode of operation of an autonomous vehicle, adapting a user interface based on the mode of operation, and providing conferencing tools, in accordance with some embodiments of the disclosure. The process 1800 may be implemented, in whole or in part, by systems or devices such as those shown in FIGS. 2 and 3. One or more actions of the process 1800 may be incorporated into or combined with one or more actions of any other process or embodiments described herein. The process 1800 may be saved to a memory or storage (e.g., any one of those depicted in FIGS. 2 and 3) as one or more instructions or routines that may be executed by a corresponding device or system to implement the process 1800.

In some embodiments, devices such as a navigation system 1810, autonomous driving platform 1820, remote conferencing platform 1830, car infotainment and video display 1840, and car camera, sensors, and controls 1850 may be used and the devices may communicate with each other to provide the embodiments discussed herein. The remote conferencing platform 1830 may also be referred to herein as a conferencing platform, server associated with the video conferencing device, driver video conferencing device, or participant (or non-driver) video conferencing device.

In some embodiments, a driver may start a trip at 1811. Once the trip is started, the control circuitry may record the trip information along with the video conference call. In some embodiments, this trip may start in a fully autonomous mode 1812. [The driver may then change from fully autonomous mode to non-autonomous mode. Accordingly, the autonomous driving platform 1820 may notify 1813 the remote conferencing platform 1830 of the driving mode change. The driving mode change may be from a fully autonomous mode 1812 when the driver starts the trip to a non-autonomous mode. If the driving mode changes to a non-autonomous mode, then the remote conferencing platform 1830 may implement an audio only 1815 video conference. However, if the current mode of operation is an autonomous mode, then the remote conferencing platform 1830 may enable video on the autonomous vehicle 1816 and display it on the car infotainment and video display 1840.

In some embodiments, once the video is enabled on the autonomous vehicle, such as at 1816, the car camera, sensors and controls 1850 may continue to detect the driver's attention at 1817. If a determination is made based that the driver's attention has changed, such as the driver is gazing at the road or manually operating the vehicle, then a still image or a cartoon image may be displayed on the car infotainment and video display 1840. However, if a determination is made that the driver's attention has not changed, i.e., the driver is still gazing at the video conference call or the current mode of operation of the vehicle continues to be in autonomous mode, then a live video of all the participants may be displayed on the car infotainment and video display 1840.

In another embodiment, the driver may start driving the car in non-autonomous mode. In this embodiment, the autonomous driving platform 1820 may notify 1822 the remote conferencing platform 1830 of the driving mode change. The car camera, sensors and controls 1850 may detect the non-autonomous mode 1821 and enable, at 1818, still images, such as cartoons or avatars that may be displayed on the car infotainment and video display 1840. In some embodiments, the car infotainment and video display 1840 may receive a signal from the car camera, sensors and controls 1850 to switch to the still images and it may update the UI of the driver remote conferencing platform at 1819 (also referred to as driver's UI or UI in the driver conferencing device) for the driver conferencing device.

In some embodiments, at 1824, the driver may trigger a bookmark using the navigation information. Accordingly, the navigation system, at 1825, may send information relating to the navigation map integrated with the bookmark to the car infotainment and video display. Alternatively, the information relating to the navigation map integrated with the bookmark may be sent to another device, such as a recording device, or the server for storage and later retrieval. Upon the car infotainment and video display receiving the navigation map information, a bookmark may be captured, such as at 1826-1828, and created at 1829. In another embodiment, any wake word, voice command, or gesture from the driver may be used as a trigger to capture a bookmark. Some examples of bookmarking options are depicted in FIG. 15 above.

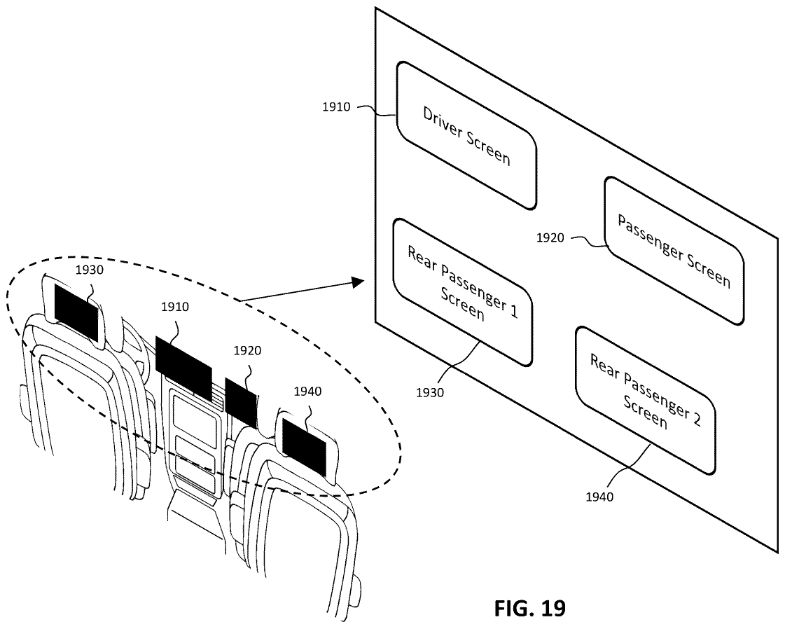

FIG. 19 is an example of an autonomous vehicle that include multiple displays that may be used as conferencing devices, in accordance with some embodiments of the disclosure. In some embodiments, an autonomous vehicle may include multiple conferencing devices 1910-1940. The conferencing devices may be integrated into the autonomous vehicle or may be conferencing devices that are portable and belong to different passengers that occupy the autonomous vehicle.

In some embodiments, when the conferencing devices may be integrated into the autonomous vehicle, the conferencing device 1910 may be located near the driver seat and be used by the driver of the autonomous vehicle for engaging in a video conference. The conferencing device 1920 may be located near the front seat passenger adjacent to the driver and be used by the front seat passenger of the autonomous vehicle for engaging in a video conference. Conferencing device 1930 and 1940 may be located in the back seat section of the autonomous vehicle and be used by passengers that sit in the back seat for engaging with a video conference. Although a 4-seat configuration is described, the embodiments are not so limited and an autonomous vehicle with any number of seats is also contemplated within the embodiments.

When the conferencing devices 1910-1940 are integrated into the autonomous vehicle, the system may recognize which conferencing device is being used. The recognition may be based on the location of the conferencing device in the autonomous vehicle, such a in different zones or behind or in front of different seats. For example, if conferencing device 1920, 1930, or 1940 are being used, then the system may recognize that those are being used by passengers and not the driver. As such the system may be able to distinguish between the conferencing device used by the driver and those that are being used by passengers. Distinguishing between which conferencing device is being used and by whom (e.g., driver vs passenger), the system may be able to distinguish between driver and non-driver video conference call. As such, if a passenger is receiving a video conference call, even though the call may be while the vehicle is in a non-autonomous mode, the system may recognize that the call is being attended by a passenger and as such full functionality of the video conference call may be provided. On the other hand, if the call is intended for the driver's conferencing device, then the embodiments as described above in relation to FIG. 9 may be implemented. In other words, the system may determine whether the car is in autonomous mode or non-autonomous mode and accordingly adjust the driver side UI associated with the driver's conferencing device. Although a certain configuration and location of conferencing devices 1910-1940 are displayed in FIG. 9, this is a non-limiting example and other the configurations and locations are also contemplated in the embodiments.

In some embodiments, the system may determine whether it is the driver or a passenger that is using the conferencing device. It may make such a determination in one of several ways.

In one embodiment, the autonomous vehicle may include a user profile that is specific to particular user. The user specific user profile may allow the user to customize many options within the autonomous vehicle, such as their seat setting, climate control, music, adjustment of rear view and side view mirrors and other customizable options. As such, a particular user sits in the autonomous car, the system may recognize the particular user and adjust all options that have been preprogrammed and associated with their profile, e.g., automatically adjust their seat and climate control to their profile settings. A particular user may also have different settings when they are a driver and when they are a passenger. The system may also determine which user account user uses when engaging in the video conference. For example, a user may have an account on Zoom, Facetime, WhatsApp, Google meet and other video conferencing platforms. The account may include their name, their video conferencing preferences, such as blurred or customized backgrounds, and other customizable features. When a video conference call that is established with a native application of the autonomous vehicle is detected, the system may match the user profile of the driver and the user profile used for joining the video conference call. If the user profiles match, then the system may determine that it is the driver of the autonomous vehicle, and not the passenger, that is currently operating the autonomous vehicle and engaging in the video conference call.

In another embodiment, the autonomous vehicle may include sensors in each seat of the autonomous vehicle. These sensors may indicate whether that seat is occupied. If a determination is made based on sensor data that only one seat in the autonomous vehicle is occupied, then the system may determine that only occupant in the autonomous vehicle is the driver. If a determination is made based on sensor data that multiple seats in the autonomous vehicle are occupied, then the system may determine based on methods such as a) user profile matching and b) cameras within the autonomous vehicle to determine which user is engaged in the video conference call.

In addition to, or in lieu of sensor data, other mechanisms and hardware in the autonomous vehicle may also be used to determine that the driver of the autonomous vehicle is the user that is engaged in the video conference call. For example, cameras that obtain an inside view of the autonomous vehicle may determine which user is driving and which user is engaged in the video conference call an accordingly change their UI adaptation.

It will be apparent to those of ordinary skill in the art that methods involved in the above-described embodiments may be embodied in a computer program product that includes a computer-usable and/or -readable medium. For example, such a computer-usable medium may consist of a read-only memory device, such as a CD-ROM disk or conventional ROM device, or a random-access memory, such as a hard drive device or a computer diskette, having a computer-readable program code stored thereon. It should also be understood that methods, techniques, and processes involved in the present disclosure may be executed using processing circuitry.

The processes discussed above are intended to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
establishing a video conference call between a plurality of devices, wherein at least one of the devices is associated with an autonomous vehicle and includes a video conferencing user interface for engaging with the video conference call;
determining whether a driver of the autonomous vehicle is using the at least one of the devices associated with the autonomous vehicle to engage with the video conference call; and
in response to determining that the driver of the autonomous vehicle is using the at least one of the devices that is associated with the autonomous vehicle to engage with the video conference call:
determining a mode of operation of the autonomous vehicle;
adapting the video conferencing user interface for the at least one of the devices that is associated with the autonomous vehicle based on the determined mode of operation of the autonomous vehicle; and
displaying the adapted video conferencing user interface on the at least one of the devices that is associated with the autonomous vehicle.

2. The method of claim 1, wherein the mode of operation is either in an autonomous or in a non-autonomous driving mode.

3-4. (canceled)

5. The method of claim 1, wherein the mode of operation includes any one of a) speed mode, b) safety mode, c) environmental mode, d) timing-based mode, or e) parked mode.

6. The method of claim 1, further comprising:
determining that the mode of operation of the vehicle is in an autonomous driving mode; and
in response to determining that the mode of operation of the vehicle is in an autonomous driving mode, adapting the video conferencing interface to display a live video associated with the video conference call.

7. The method of claim 6, further comprising:
determining that the mode of operation of the vehicle has switched from the autonomous driving mode to a non-autonomous mode; and
in response to determining the switch to the non-autonomous mode, switching from displaying the live video to displaying a still image, wherein the still image is any one of a) a cartoon for each user associated with a device, from the plurality of devices, joined into the established video conference call, b) an avatar for each user associated with the device, from the plurality of devices, joined into the established video conference call, c) an image of the user associated with each device, or d) a photograph of the user associated with each device, from the plurality of devices, joined into the established video conference call.

8. (canceled)

9. The method of claim 1, further comprising:
determining that the mode of operation of the vehicle is currently in a non-autonomous mode;
determining that a passenger of the autonomous vehicle is using the at least one of the devices that is associated with the autonomous vehicle to engage with the video conference call; and
in response to the determination that the passenger of the autonomous vehicle is using the at least one of the devices that is associated with the autonomous vehicle, adapting the video conferencing interface of the at least one of the devices that is associated with the autonomous vehicle to display a live video associated with the video conference call.

10. The method of claim 1, wherein determining that the driver of the autonomous vehicle is using the at least one of the devices that is associated with the autonomous vehicle further comprises:
determining that a user profile that is associated with the autonomous vehicle is being used when the determined mode of operation of the autonomous vehicle is in a non-autonomous mode;
determining whether the user profile that is associated with the autonomous vehicle being used is of a same user as a user profile being used to engage in the video conference call; and
in response to determining that the same user is using the user profile that is associated with the autonomous vehicle and the user profile associated with the video conference call, determining that the user is currently the driver of the autonomous vehicle who is using the at least one of the devices that is associated with the autonomous vehicle to engage with the conference call.

11-12. (canceled)

13. The method of claim 1, further comprising:
displaying a participant video or content on the video conferencing user interface;
determining interaction with the displayed participant or content by a user of the video conferencing user interface; and
automatically recording the interaction along with a recording of the video conference call.

14. The method of claim 1, further comprising:
displaying, on the video conferencing user interface of the first device, still images of a plurality of participants associated with the plurality of devices joined into the video conference call;
detecting a change in emotion of a participant that is above a predetermined emotion threshold, from the plurality of participants; and
in response to detecting the change is emotion above the predetermined emotion threshold, switching from the still image of the participant to a live video of the participant.

15. (canceled)

16. The method of claim 14, further comprising:
monitoring gaze of a user associated with the at least one of the devices that is associated with the autonomous vehicle;
determining, based on the monitoring, that the user's gaze is directed away from the video conferencing user interface; and
in response to determining that the user's gaze is directed away from the video conferencing user interface, displaying a blank screen on the video conferencing user interface of the at least one of the devices that is associated with the autonomous vehicle.

17. The method of claim 14, further comprising, deactivating live video of other participants of the video conference call that are not currently speaking.

18. A system comprising:
communications circuitry configured to access a plurality of devices; and
control circuitry configured to:
establish a video conference call between the plurality of devices, wherein at least one of the devices is associated with an autonomous vehicle and includes a video conferencing user interface for engaging with the video conference call;
determine whether a driver of the autonomous vehicle is using the at least one of the devices associated with the autonomous vehicle to engage with the video conference call; and
in response to determining that the driver of the autonomous vehicle is using the at least one of the devices that is associated with the autonomous vehicle to engage with the video conference call:
determine a mode of operation of the autonomous vehicle;
adapt the video conferencing user interface for the at least one of the devices that is associated with the autonomous vehicle based on the determined mode of operation of the autonomous vehicle; and
display the adapted video conferencing user interface on the at least one of the devices that is associated with the autonomous vehicle.

19. The system of claim 18, wherein the mode of operation is either in an autonomous or in a non-autonomous driving mode.

20-21. (canceled)

22. The system of claim 18, wherein the mode of operation includes any one of a) speed mode, b) safety mode, c) environmental mode, d) timing-based mode, or e) parked mode.

23. The system of claim 18, further comprising, the control circuitry configured to:
determine that the mode of operation of the vehicle is in an autonomous driving mode; and
in response to determining that the mode of operation of the vehicle is in an autonomous driving mode, adapt the video conferencing interface to display a live video associated with the video conference call.

24. The system of claim 23, further comprising, the control circuitry configured to:
determine that the mode of operation of the vehicle has switched from the autonomous driving mode to a non-autonomous mode; and
in response to determining the switch to the non-autonomous mode, switch from displaying the live video to displaying a still image, wherein the still image is any one of a) a cartoon for each user associated with a device, from the plurality of devices, joined into the established video conference call, b) an avatar for each user associated with the device, from the plurality of devices, joined into the established video conference call, c) an image of the user associated with each device, or d) a photograph of the user associated with each device, from the plurality of devices, joined into the established video conference call.

25. (canceled)

26. The system of claim 18, further comprising, the control circuitry configured to:
determine that the mode of operation of the vehicle is currently in a non-autonomous mode;
determine that a passenger of the autonomous vehicle is using the at least one of the devices that is associated with the autonomous vehicle to engage with the video conference call; and
in response to the determination that the passenger of the autonomous vehicle is using the at least one of the devices that is associated with the autonomous vehicle, adapt the video conferencing interface of the at least one of the devices that is associated with the autonomous vehicle to display a live video associated with the video conference call.

27. The system of claim 18, wherein determining that the driver of the autonomous vehicle is using the at least one of the devices that is associated with the autonomous vehicle further comprises, the control circuitry configured to:
determine that a user profile that is associated with the autonomous vehicle is being used when the determined mode of operation of the autonomous vehicle is in a non-autonomous mode;
determine whether the user profile that is associated with the autonomous vehicle being used is of a same user as a user profile being used to engage in the video conference call; and
in response to determining that the same user is using the user profile that is associated with the autonomous vehicle and the user profile associated with the video conference call, determine that the user is currently the driver of the autonomous vehicle who is using the at least one of the devices that is associated with the autonomous vehicle to engage with the conference call.

28-29. (canceled)

30. The system of claim 18, further comprising, the control circuitry configured to:
display a participant video or content on the video conferencing user interface;
determine interaction with the displayed participant or content by a user of the video conferencing user interface; and
automatically record the interaction along with a recording of the video conference call.

31. The system of claim 18, further comprising, the control circuitry configured to:
display, on the video conferencing user interface of the first device, still images of a plurality of participants associated with the plurality of devices joined into the video conference call;
detect a change in emotion of a participant that is above a predetermined emotion threshold, from the plurality of participants; and
in response to detecting the change is emotion above the predetermined emotion threshold, switch from the still image of the participant to a live video of the participant.

32. (canceled)

33. The system of claim 31, further comprising, the control circuitry configured to:
monitor gaze of a user associated with the at least one of the devices that is associated with the autonomous vehicle;
determine, based on the monitoring, that the user's gaze is directed away from the video conferencing user interface; and
in response to determining that the user's gaze is directed away from the video conferencing user interface, display a blank screen on the video conferencing user interface of the at least one of the devices that is associated with the autonomous vehicle.

34. The system of claim 31, further comprising, the control circuitry configured to deactivate live video of other participants of the video conference call that are not currently speaking.
